(19) United States
(12) Patent Application Publication
(10) Pub. No.: US 2026/0072237 A1
(43) Pub. Date: Mar. 12, 2026

(54) LENS BARREL

(71) Applicant: Panasonic Intellectual Property Management Co., Ltd., Osaka (JP)

(72) Inventor: Tetsuya UNO, Osaka (JP)

(73) Assignee: Panasonic Intellectual Property Management Co., Ltd., Osaka (JP)

(21) Appl. No.: 19/317,232

(22) Filed: Sep. 3, 2025

(30) Foreign Application Priority Data
Sep. 6, 2024 (JP) 2024-154163
Aug. 21, 2025 (JP) 2025-138371

(51) Int. Cl. G02B 7/10; G02B 7/02; G03B 9/02; G03B 13/34; G03B 17/12; G03B 17/18

(52) U.S. Cl. CPC G02B 7/10; G02B 7/021; G03B 9/02; G03B 13/34; G03B 17/12; G03B 17/18

(57) ABSTRACT

A lens barrel includes a main body having a substantially cylindrical portion; one or a plurality of lenses; one or a plurality of lens support members that support the one or the plurality of lenses; a lens drive member having a substantially cylindrical portion that moves the one or the plurality of lens support members in a substantially extending direction of an optical axis in conjunction with rotation with respect to the main body nearly around the optical axis of the one or the plurality of lenses; a rotation operation interlocking member disposed radially outward of the lens drive member nearly around the optical axis, the rotation operation interlocking member including a substantially cylindrical portion rotated with respect to the main body nearly around the optical axis in conjunction with a manual operation; an odd number of rotating bodies engaging with an outer circumferential surface of the lens drive member and an inner circumferential surface of the rotation operation interlocking member and capable of executing a rolling operation on the outer circumferential surface and the inner circumferential surface around a rotation center line substantially parallel to the optical axis and a circling operation around the optical axis; and a lens moving direction switching member that switches from a state in which the rolling operation of the odd number of rotating bodies is regulated and the circling operation is permitted to a state in which the rolling operation is permitted and the circling operation is regulated, or vice versa. A moving direction of the lens with respect to a rotation direction of the rotation operation interlocking member is switched by executing switching of the lens moving direction switching member.

### BACKGROUND

### Technical Field

The present disclosure relates to a lens barrel.

### Description of the Related Art

Conventionally, there has been known a lens barrel capable of adjusting photographing conditions by a user rotating a cylindrical member (rotation operation interlocking member) provided in the lens barrel.

For example, a lens barrel capable of adjusting a focal length, a lens barrel capable of adjusting a focus position, a lens barrel capable of adjusting a aperture amount, and the like are known.

A lens barrel whose focal length is adjustable, that is, a lens barrel with a zoom function includes a lens movable in an optical axis direction and a zoom ring (rotation operation interlocking member) that moves the lens in an extending direction of the optical axis. When the user performs a rotation operation on the zoom ring, the lens moves in the extending direction of the optical axis, and the focal length is adjusted. A lens barrel whose focus position is adjustable, that is, a lens barrel with a focus function includes a lens movable in an optical axis direction and a focus ring (rotation operation interlocking member) that move the lens in an extending direction of the optical axis. When the user performs a rotation operation on the focus ring, the lens moves in the extending direction of the optical axis, and the focus position is adjusted. A lens barrel capable of adjusting an amount of light passing through a lens, that is, a lens barrel with an aperture amount (F value) change function includes at least one diaphragm blade and an aperture ring (rotation operation interlocking member) that rotationally drives the at least one diaphragm blade. When the user performs a rotation operation on the aperture ring, each of the at least one diaphragm blade moves in a direction intersecting the optical axis, and the aperture amount (F value) for changing the amount of light passing therebetween is adjusted.

In the above-described lens barrel with zoom function, lens barrel with focus function, and lens barrel with aperture (F value) change function, when the rotation operation interlocking member is rotated in one rotation direction, the focal length and the aperture amount (F value) increase, and when the rotation operation interlocking member is rotated in the other rotation direction, the focal length and the aperture amount (F value) decrease. That is, the rotation direction of the rotation operation interlocking member when the adjustment amount is increased or decreased is determined and cannot be changed. However, there is a lens barrel capable of changing the rotation direction of the rotation operation interlocking member when the adjustment amount is increased or decreased.

For example, JP10-10407A and WO2018/047460A disclose lens barrels in which a lens moves in an extending direction of an optical axis when a user rotates a cylindrical zoom ring (rotation operation interlocking member). These lens barrels include a zoom direction switching switch for a user to switch a moving direction of the lens with respect to a rotation direction of the zoom ring from a front direction (subject side direction) to a rear direction (camera body side direction) or vice versa.

In the lens barrel described in JP10-10407A, when the user operates the zoom direction switching switch, the rotation direction of the motor that drives the lens with respect to the rotation direction of the zoom ring is switched from normal rotation to reverse rotation or from reverse rotation to normal rotation, whereby the moving direction of the lens with respect to the rotation direction of the zoom ring is switched.

Further, in the lens barrel described in WO2018/047460A, a switching mechanism that switches an operation direction of the optical element is provided in an interlocking body (lens driving member) that operates the optical element, and when a user operates a mode change switch, a rotation direction of the interlocking body with respect to a rotation direction of the zoom ring is switched from normal rotation to reverse rotation or from reverse rotation to normal rotation, whereby a moving direction of the lens with respect to the rotation direction of the zoom ring is switched.

### SUMMARY

However, in the case of the lens barrel described in JP10-10407A, an electronic component such as a motor is required. Further, in the case of the lens barrel described in WO2018/047460A, a complicated switching mechanism is required.

Therefore, an object of the present disclosure is to easily change a rotation direction of a rotation operation interlocking member when an adjustment amount is increased or decreased without using an electronic component such as a motor and without including a complicated switching mechanism, in a lens barrel in which a photographing condition can be adjusted by a user performing a rotation operation on the rotation operation interlocking member provided in the lens barrel.

In order to solve the above problem, according to an aspect of the present disclosure, a lens barrel is provided that includes:
a main body having a substantially cylindrical portion;
one or a plurality of lenses;
one or a plurality of lens support members that support the one or the plurality of lenses;
a lens drive member having a substantially cylindrical portion that moves the one or the plurality of lens support members in a substantially extending direction of an optical axis in conjunction with rotation with respect to the main body nearly around the optical axis of the one or the plurality of lenses;
a rotation operation interlocking member disposed radially outward of the lens drive member nearly around the optical axis, the rotation operation interlocking member including a substantially cylindrical portion rotated with respect to the main body nearly around the optical axis in conjunction with a manual operation;
an odd number of rotating bodies engaging with an outer circumferential surface of the lens drive member and an inner circumferential surface of the rotation operation interlocking member and capable of executing a rolling operation on the outer circumferential surface and the inner circumferential surface around a rotation center line substantially parallel to the optical axis and a circling operation around the optical axis; and
a lens moving direction switching member that switches from a state in which the rolling operation of the odd number of rotating bodies is regulated and the circling operation is permitted to a state in which the rolling operation is permitted and the circling operation is regulated, or vice versa, wherein
a moving direction of the lens with respect to a rotation direction of the rotation operation interlocking member is switched by executing switching of the lens moving direction switching member.

According to another aspect of the present disclosure, a lens barrel is provided that includes:
one or a plurality of lenses;
one or a plurality of diaphragm blades that adjust an amount of light passing through the one or a plurality of lenses;
a substantially annular base member that rotatably supports the one or the plurality of diaphragm blades around a rotation center line parallel to an optical axis of the one or a plurality of lenses;
a diaphragm blade drive member that opens and closes the one or a plurality of diaphragm blades in conjunction with rotation with respect to the base member nearly around an optical axis of the one or a plurality of lenses;
a rotation operation interlocking member disposed radially outside the diaphragm blade drive member nearly around the optical axis, the rotation operation interlocking member including a substantially cylindrical portion rotated with respect to the main body nearly around the optical axis in conjunction with a manual operation;
an odd number of rotating bodies engaging with an outer circumferential surface of the diaphragm blade drive member and an inner circumferential surface of the rotation operation interlocking member and capable of executing a rolling operation on the outer circumferential surface and the inner circumferential surface around a rotation center line substantially parallel to the optical axis and a circling operation around the optical axis; and
a switching member that switches from a state in which the rolling operation of the odd number of rotating bodies is regulated and the circling operation is permitted to a state in which the rolling operation is permitted and the circling operation is regulated, or vice versa, wherein
opening and closing directions of the one or a plurality of diaphragm blades with respect to a rotation direction of the rotation operation interlocking member is switched by executing switching of the switching member.

According to the present disclosure, in a lens barrel capable of adjusting a photographing condition by a user rotating a rotation operation interlocking member provided in the lens barrel, a rotation direction of the rotation operation interlocking member when an adjustment amount is increased or decreased can be easily changed without using an electronic component such as a motor and without including a complicated switching mechanism.

### BRIEF DESCRIPTION OF DRAWINGS

FIG. 1 is a perspective view of a lens barrel in a state of wide-angle photography (shortest optical system) as viewed obliquely from front according to an embodiment;

FIG. 2 is a perspective view of the lens barrel in a state of telephotography (longest optical system) as viewed obliquely from the front;

FIG. 3 is a cross-sectional view of the lens barrel as viewed from a side surface in a state of wide-angle photography (shortest optical system);

FIG. 4 is a cross-sectional view of the lens barrel as viewed from the side surface in a state of telephotography (longest optical system);

FIG. 5 is an exploded perspective view of the lens barrel as viewed obliquely from the front;

FIG. 6 is an exploded perspective view of the lens barrel as viewed obliquely from the rear;

FIG. 7 is a perspective view of the lens barrel in a state in which the rotation operation interlocking member and the lens moving direction switching member are removed as viewed obliquely from the front;

FIG. 8 is a perspective view of the lens moving direction switching member as viewed from an oblique rear side;

FIG. 9 is a perspective view of the lens barrel in a state in which the lens moving direction switching member is removed in a state of wide-angle photography (shortest optical system), as viewed from an oblique rear side;

FIG. 10 is a cross-sectional view illustrating a positional relationship among a lens drive member, a rotation operation interlocking member, and a gear (rotating body) in a state of wide-angle photography (shortest optical system) as viewed from the front;

FIG. 11A is a cross-sectional view illustrating a first positional relationship among a lens drive member, a rotation operation interlocking member, and a gear (rotating body) in a state of telephotography (longest optical system) as viewed from the front;

FIG. 11B is a cross-sectional view illustrating a second positional relationship among the lens drive member, the rotation operation interlocking member, and the gear (rotating body) in a state of telephotography (longest optical system) as viewed from the front; and

FIG. 12 is a side view of an example lens barrel including a scale of a focal length.

### DETAILED DESCRIPTION

Hereinafter, embodiments will be described in detail with reference to the drawings as appropriate. However, a detailed description more than necessary may be omitted in some cases. For example, a detailed description of a well-known matter and a repeated description of substantially the same configuration may be omitted. This is to avoid unnecessary redundancy of the following description and to facilitate understanding of those skilled in the art.

In addition, the inventor(s) provides the accompanying drawings and the following description in order for those skilled in the art to fully understand the present disclosure, and it is not intended to limit the subject matter described in the claims by these.

Hereinafter, an imaging device according to an embodiment of the present disclosure will be described with reference to the drawings.

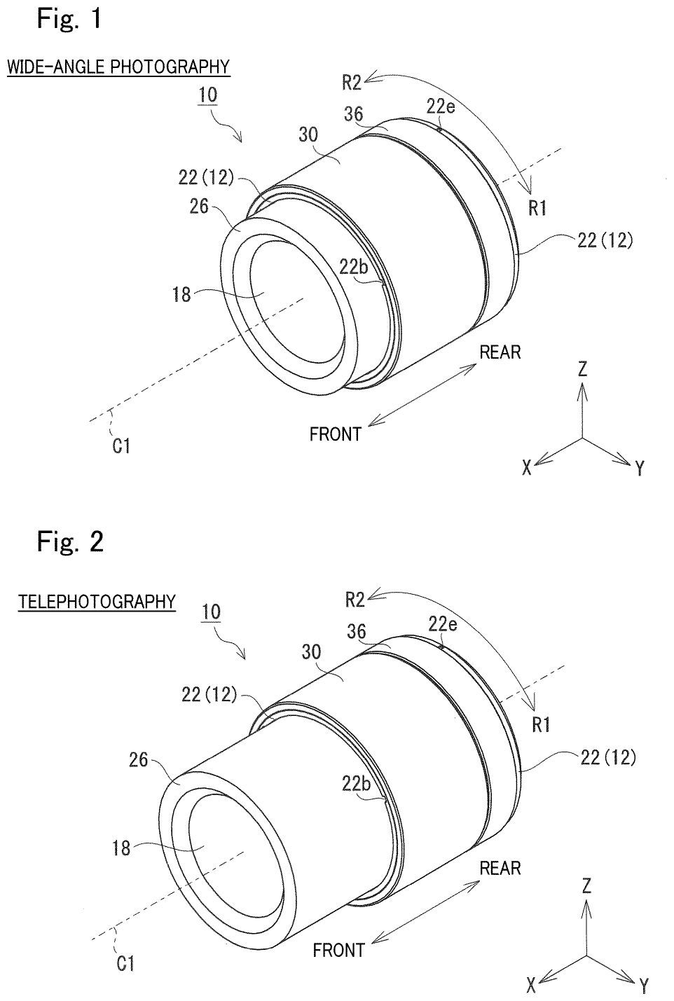

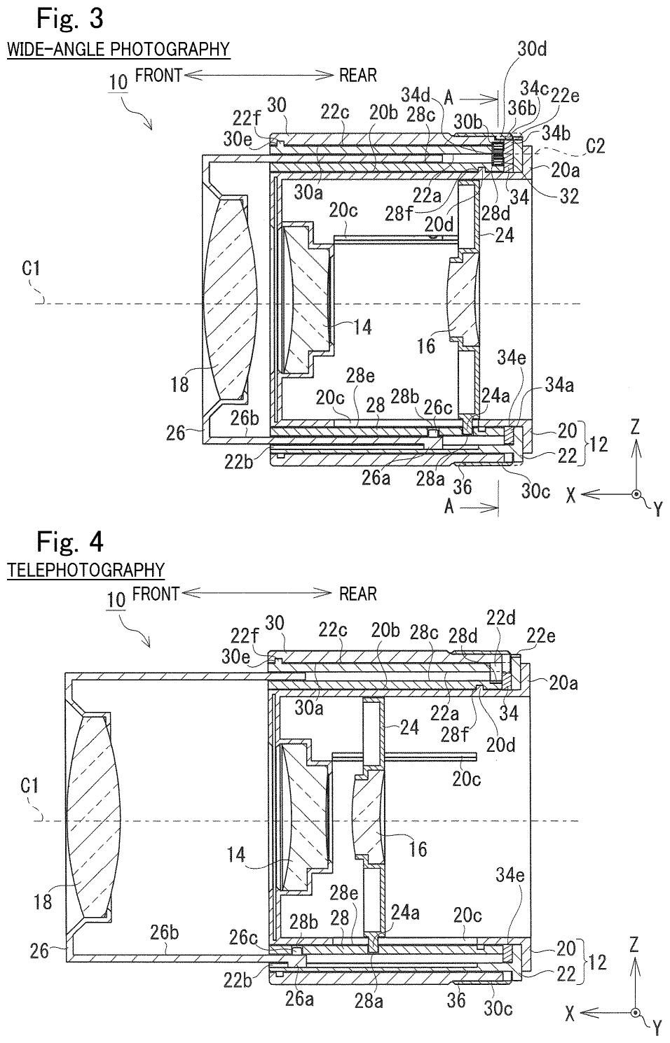

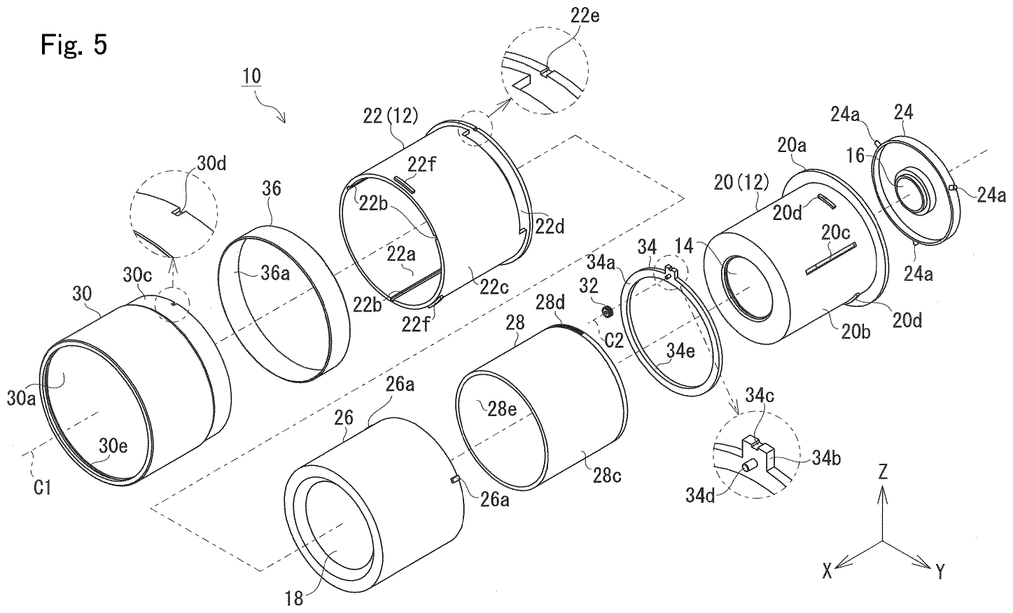

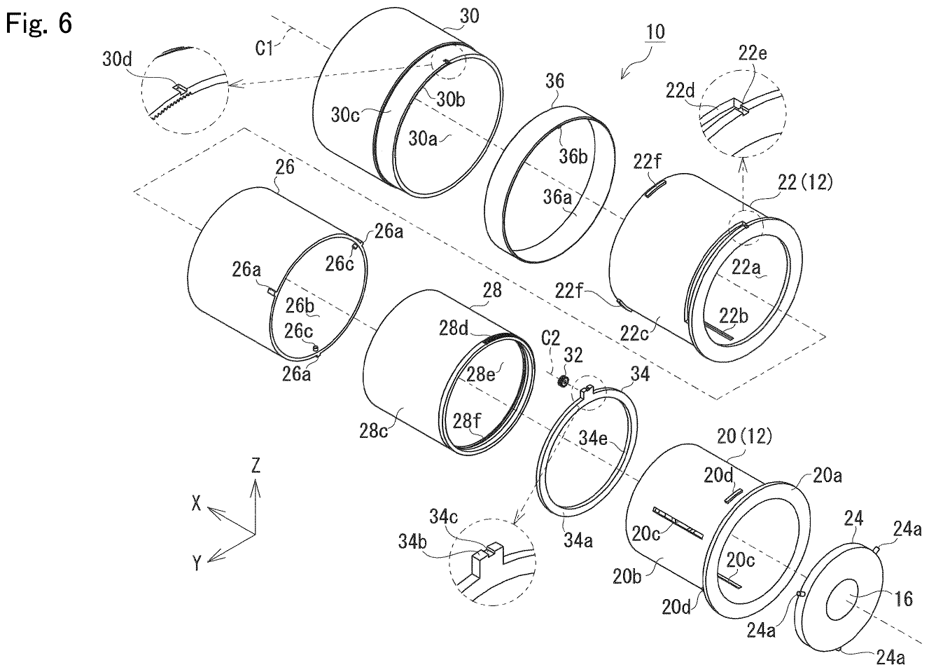

FIGS. 1 and 2 are perspective views of a lens barrel according to an embodiment of the present disclosure as viewed obliquely from the front, and FIGS. 3 and 4 are cross-sectional views of the lens barrel as viewed from a side surface. FIG. 5 is an exploded perspective view of the lens barrel as viewed obliquely from the front, and FIG. 6 is an exploded perspective view of the lens barrel as viewed obliquely from the rear.

Here, the X-Y-Z orthogonal coordinate system illustrated in the drawings is for facilitating understanding of the embodiment of the present disclosure, and does not limit the embodiment of the present disclosure. The X-axis direction is a front-rear direction of the lens barrel, the Y-axis direction is a left-right direction, and the Z-axis direction is a height direction. In addition, a side where a subject is present at the time of photographing is a front side of the lens barrel, and a side where an imaging apparatus (camera body) to which the lens barrel is detachably attached is present is a rear side of the lens barrel.

A lens barrel 10 illustrated in FIGS. 1 to 4 illustrates an example in which an interval between two or more lenses in a substantially extending direction of an optical axis is changed by relatively moving the two or more lenses in the substantially extending direction of the optical axis, and a zooming (focal length change) operation is performed. Specifically, by changing the interval between a plurality of lenses 14, 16, and 18, a wide-angle photograph and a telephotograph can be taken. FIGS. 1 and 3 illustrate the lens barrel 10 in a state of wide-angle photography (shortest optical system). FIGS. 2 and 4 illustrate the lens barrel 10 in a state of telephotography (longest optical system).

In the lens barrel according to an embodiment of the present disclosure, the wide-angle photographing state is set in the state where the entire optical system length is the shortest, and the telephotographing state is set in the state where the entire optical system length is the longest, but the present embodiment is not limited thereto. Due to the convenience of optical design, characteristics such as a lens focal length and a zoom magnification, and various restrictions, the telephotographing state may be set in a state where the entire optical system length is the shortest, and the wide-angle photographing state may be set in a state where the entire optical system length is the longest. Furthermore, the telephotographing state or the wide-angle photographing state may be set in a state where the entire optical system length is the longest, and the photographing state in which a focal length is between that in the wide-angle photographing state and that in the telephotographing state may be set in a state where the entire optical system length is the shortest. In this case, when the zoom operation is performed from the wide-angle photographing state to the telephotographing state, the entire optical system length transitions from a long state to a long state again via a short state, and at least one lens has a U-turn trajectory. However, the same effect as that of the present embodiment can be obtained even in this state.

Furthermore, in the lens barrel according to an embodiment of the present disclosure, an example in which a zoom (focal length change) operation that a focal length is adjustable is performed by relatively moving two or more lenses in a substantially extending direction of an optical axis has been described, but the present embodiment is not limited thereto. A focus (focus position adjustment, focus adjustment) operation that a focus position is adjustable may be performed by moving at least one lens in a substantially extending direction of the optical axis. Alternatively, a diaphragm operation that an amount of light passing through the lens is adjustable may be performed in which at least one diaphragm blade is opened and closed in a direction substantially orthogonal to the optical axis to change the size of an aperture formed by the diaphragm blade to adjust the amount of light passing. Even in these cases, the same effects as those of the present embodiment can be obtained.

As illustrated in FIGS. 3 to 6, the lens barrel 10 includes a main body 12 and a plurality of lenses 14, 16, and 18. The lens barrel 10 is detachably attached to a body mount (not illustrated) of the imaging apparatus (camera body) via a lens mount (not illustrated) fixed to the main body 12.

In the present embodiment, the main body 12 includes two cylindrical bodies 20 and 22.

The inner cylindrical body 20 in the main body 12 is a cylindrical member having a substantially cylindrical portion, and holds the lens 14 on the front end side thereof. The inner cylindrical body 20 includes a flange portion 20a on the rear end side. The lens mount is attached directly or indirectly via a separate member to a surface on the rear side of the flange portion 20a of the inner cylindrical body 20 or the rear end side of the outer cylindrical body 22. Specifically, in a state where the lens mount is mounted on the body mount, the main body 12 of the lens barrel 10 is fixed to the lens mount such that an optical axis C1 passes through substantially the center of the light receiving surface of the imaging element mounted on the imaging apparatus (camera body) and the optical axis C1 is substantially orthogonal to the light receiving surface.

The outer cylindrical body 22 of the main body 12 is a cylindrical member having a substantially cylindrical portion, and accommodates the inner cylindrical body 20 between an inner circumferential surface 22a and an outer circumferential surface 20b of the inner cylindrical body 20 with a gap formed over the entire circumference around the optical axis C1. The rear end of the outer cylindrical body 22 is fixed to the flange portion 20a of the inner cylindrical body 20.

The lenses 14, 16, and 18 are disposed such that their optical axes are substantially located on substantially the same straight line (optical axis C1 of lens barrel 10).

As described above, the lens 14 (fixed lens) is provided on the front end side of the inner cylindrical body 20 in the main body 12. That is, the lens 14 is a lens fixed to the main body 12, and does not move in a substantially extending direction (X-axis direction) of the optical axis C1 of the lens barrel 10.

The lenses 16 and 18 (first and second movable lenses) are provided in the lens barrel 10 so as to be movable in a substantially extending direction (X-axis direction) of the optical axis C1 of the lens barrel 10 with respect to the main body 12.

The lens 16 is located behind the lens 14. In addition, the lens 16 is supported by an annular first lens support member 24 that is movable in a substantially extending direction (X-axis direction) of the optical axis C1.

Specifically, the first lens support member 24 is accommodated in the inner cylindrical body 20 of the main body 12, that is, on the inner diameter side around the optical axis C1 of the inner cylindrical body 20. In the inner cylindrical body 20, one or a plurality of guide grooves 20c linearly extending in a substantially extending direction (X-axis direction) of the optical axis C1 and penetrating in a radial direction around the optical axis C1 are formed. The first lens support member 24 includes one or a plurality of cam followers 24a that engage with one or a plurality of guide grooves 20c. One or a plurality of cam followers 24a are engaged with and guided by the corresponding guide grooves 20c, whereby the first lens support member 24 is supported by the inner cylindrical body 20 in the main body 12 so as to be movable in the substantially extending direction of the optical axis C1. A method of moving the first lens support member 24 will be described later.

The lens 18 is located in front of the lens 14. The lens 18 is provided on the front end side of a cylindrical second lens support member 26 having a substantially cylindrical portion movable in the substantially extending direction (X-axis direction) of the optical axis C1.

Specifically, in the second lens support member 26, at least a part of the substantially cylindrical portion is accommodated in a space between the inner cylindrical body 20 and the outer cylindrical body 22 in the main body 12, that is, outside the inner cylindrical body 20 and inside the outer cylindrical body 22 in the radial direction around the optical axis C1. One or a plurality of guide grooves 22b extending in the substantially extending direction (X-axis direction) of the optical axis C1 is formed in the inner circumferential surface 22a of the outer cylindrical body 22. The second lens support member 26 includes one or a plurality of protrusions 26a that protrude outward in the radial direction around the optical axis C1 and engage with one or a plurality of guide grooves 22b, respectively. One or a plurality of protrusions 26a are engaged with and guided by the corresponding guide groove 22b, whereby the second lens support member 26 is supported by the outer cylindrical body 22 in the main body 12 so as to be movable in the substantially extending direction of the optical axis C1. A method of moving the second lens support member 26 will be described later.

In the present embodiment, each of lenses 14, 16, and 18 is illustrated as a single lens, but the present embodiment is not limited thereto. One or a plurality of the lenses 14, 16, and 18 may be a lens group including a plurality of lenses of different types.

In the present embodiment, the fixed lens provided in the lens barrel 10 is one of lenses 14 (fixed lens), but the present embodiment is not limited thereto. In addition to the lens 14, one or a plurality of lenses or a lens group may be fixed, or the total number of fixed lenses may be 0.

In the present embodiment, lenses provided in the lens barrel 10 and movable in the substantially extending direction (X-axis direction) of the optical axis C1 are two lenses 16 and 18 (first and second movable lenses), but the present embodiment is not limited thereto. In addition to the lenses 16 and 18, one or a plurality of lenses or a lens group may be supported so as to be movable in the substantially extending direction (X-axis direction) of the optical axis C1, or the total number of movable lenses may be one.

The first lens support member 24 that supports the lens 16 and the second lens support member 26 that supports the lens 18 are driven in a substantially extending direction (X-axis direction) of the optical axis C1 by a lens drive member 28. More specifically, the first lens support member 24 moves in the substantially extending direction (X-axis direction) of the optical axis C1 by a known cam mechanism including the lens drive member 28 and the inner cylindrical body 20, and similarly, the second lens support member 26 moves in the substantially extending direction (X-axis direction) of the optical axis C1 by a known cam mechanism including the lens drive member 28 and the outer cylindrical body 22. Therefore, in order to switch the moving direction of the lens 16 and the lens 18 in the substantially extending direction (X-axis direction) of the optical axis C1, which is one of the objects of the present application, it is only required to switch the rotation direction of the lens drive member 28 nearly around the optical axis C1. When the rotation direction of the lens drive member 28 is reversed (in the opposite direction), that is, when the rotation direction is switched from the normal rotation to the reverse rotation or vice versa, the cam groove included in the cam mechanism is reversely rotated, and the trajectory of the cam is traced in the reverse direction (opposite direction), so that the moving directions of the first lens support member 24 and the second lens support member 26 in the substantially extending direction (X-axis direction) of the optical axis C1 are switched in the reverse direction (opposite direction), that is, from the front direction (extending direction) to the rear direction (withdrawing direction) or vice versa.

The lens drive member 28 is a cylindrical member having a substantially cylindrical portion, and is accommodated between the inner cylindrical body 20 and the substantially cylindrical portion of the second lens support member 26 in the main body 12, that is, outside the inner cylindrical body 20 and inside the substantially cylindrical portion of the second lens support member 26 in the radial direction around the optical axis C1. In addition, the inner circumferential surface 28e substantially radially fits on the outer circumferential surface 20b of the inner cylindrical body 20, so that the lens drive member 28 is regulated in the radial direction, and is supported rotatably around the optical axis C1 along the outer circumferential surface 20b. In addition, a bayonet claw 20d protruding from the outer circumferential surface 20b of the inner cylindrical body 20 is substantially fitted into a bayonet groove 28f, so that the lens drive member 28 is rotatably supported around the optical axis C1 in a state where the direction of the optical axis C1 is regulated.

As illustrated in FIGS. 3 and 4, the lens drive member 28 includes one or a plurality of first and second cam grooves 28a and 28b in the present embodiment. Each of the first and second cam grooves 28a and 28b has a known cam groove shape, and extends in the circumferential direction of the substantially cylindrical portion of the lens drive member 28 while extending in the substantially extending direction (X-axis direction) of the optical axis C1, that is, extends in an oblique direction with respect to the optical axis C1 as viewed in a direction orthogonal to the optical axis C1 (as viewed in the Y-axis direction and the Z-axis direction). In other words, each of the first and second cam grooves 28a and 28b extends along a substantially spiral trajectory around the optical axis C1 in the substantially cylindrical portion of the lens drive member 28. In FIGS. 5 and 6, the first and second cam grooves 28a and 28b are not illustrated for simplification of the drawing.

In addition, in the case of the present embodiment, each of the first and second cam grooves 28a and 28b extends in an oblique direction with respect to the optical axis C1 as viewed in a direction orthogonal to the optical axis C1 (as viewed in the Y-axis direction and the Z-axis direction), but the present embodiment is not limited thereto. In a similar direction view, each of the first and second cam grooves 28a and 28b may include a portion extending in a direction orthogonal to the optical axis C1, that is, a portion where the angle formed with the optical axis C1 is constant at +90° or the like, or may include a portion where the angle in the oblique direction with respect to the optical axis C1 changes, for example, a portion where the angle formed with the optical axis C1 is +45° to −60° (U-turn trajectory) or the like.

One or the plurality of first cam grooves 28a of the lens drive member 28 are respectively engaged with one or the plurality of cam followers 24a provided on the outer peripheral side of the first lens support member 24 penetrating the guide groove 20c of the inner cylindrical body 20 in the main body 12. When the lens drive member 28 rotates, the cam follower 24a of the first lens support member 24 relatively moves inside the first cam groove 28a along the trajectory of the first cam groove 28a while maintaining the engagement with the first cam groove 28a. At the same time, as described above, the cam follower 24a of the first lens support member 24 is engaged with and guided by the guide groove 20c of the inner cylindrical body 20, thereby being supported movably in the substantially extending direction of the optical axis C1. Therefore, when the lens drive member 28 rotates, the first lens support member 24 moves in the substantially extending direction (X-axis direction) of the optical axis C1 by a known cam mechanism configured by the engagement between the first cam groove 28a and the cam follower 24a and the engagement between the guide groove 20c and the cam follower 24a. As a result, the lens 16 moves in the substantially extending direction of the optical axis C1 by the rotation of the lens drive member 28.

One or the plurality of second cam grooves 28b of the lens drive member 28 are respectively engaged with one or the plurality of cam followers 26c provided on the inner circumferential surface 26b of the second lens support member 26. When the lens drive member 28 rotates, the cam follower 26c of the second lens support member 26 relatively moves inside the second cam groove 28b along the trajectory of the second cam groove 28b while maintaining the engagement with the second cam groove 28b. At the same time, as described above, the protrusion 26a of the second lens support member 26 is supported to be movable in the substantially extending direction of the optical axis C1 by being engaged with and guided by the guide groove 22b of the outer cylindrical body 22. Therefore, when the lens drive member 28 rotates, the second lens support member 26 moves in the substantially extending direction of the optical axis C1 (X-axis direction) by a known cam mechanism configured by the engagement between the second cam groove 28b and the cam follower 26c and the engagement between the guide groove 22b and the protrusion 26a. As a result, the lens 18 moves in the substantially extending direction of the optical axis C1 by the rotation of the lens drive member 28.

By the rotation of the lens drive member 28, the first and second lens support members 24 and 26 move in the substantially extending direction (X-axis direction) of the optical axis C1 in conjunction with each other. Specifically, as illustrated in FIGS. 3 and 4, in a case of shifting from wide-angle photography to telephotography, that is, in a case of zooming from a wide-angle to a telephoto, the first and second lens support members 24 and 26 move in conjunction with each other such that the lens 18 moves away from the lens 14 while the lens 16 approaches the lens 14. In that state, the first and second lens support members 24 and 26 extend in the substantially extending direction of the optical axis C1 with respect to the main body 12. As a result, the entire length of the lens barrel 10 in the substantially extending direction of the optical axis C1 increases. Furthermore, in a case of shifting from telephotography to wide-angle photography, that is, in a case of zooming from a telephoto to a wide-angle, the first and second lens support members 24 and 26 move in conjunction with each other such that the lens 18 approaches the lens 14 while the lens 16 moves away from the lens 14. In that state, the first and second lens support members 24 and 26 withdraw in the substantially extending direction of the optical axis C1 with respect to the main body 12. As a result, the entire length of the lens barrel 10 in the substantially extending direction of the optical axis C1 decreases.

In the case of the present embodiment, the wide-angle photographing state is set in a state where the entire optical system length is the shortest, and the telephotographing state is set in a state where the entire optical system length is the longest, but the present embodiment is not limited thereto. As described above, the telephotographing state may be set in a state where the entire optical system length is the shortest, and the wide-angle photographing state may be set in a state where the entire optical system length is the longest. In that case, when zooming from a wide-angle to a telephoto, the lens 18 moves so as to approach the lens 14, and the entire length of the lens barrel 10 in the substantially extending direction of the optical axis C1 decreases. In addition, when zooming from a telephoto to a wide angle, the lens 18 moves away from the lens 14, and the entire length of the lens barrel 10 in the substantially extending direction of the optical axis C1 increases.

In addition, as described above, the telephotographing state or the wide-angle photographing state may be set in a state where the entire optical system length is the longest, and the photographing state in which a focal length is between that in the wide-angle photographing state and that in the telephotographing state may be set in a state where the entire optical system length is the shortest. In that case, when zooming from a wide-angle to a telephoto, the lens 18 first moves to approach the lens 14, and then moves away from the lens 14. The entire length of the lens barrel 10 in the substantially extending direction of the optical axis C1 first decreases and then increases (U-turn operation). A similar U-turn operation is performed also when zooming is performed from a telephoto to a wide-angle.

Since the lens drive member 28 is accommodated between the inner cylindrical body 20 and the cylindrical second lens support member 26 having a substantially cylindrical portion in the main body 12, the user cannot directly rotate the lens drive member by manual operation. In order for the user to rotate the lens drive member 28 in conjunction with the manual operation, a rotation operation interlocking member 30 drivingly connected to the lens drive member 28 is provided on the outer peripheral side (radially outer side) of the lens barrel 10 around the optical axis C1.

The rotation operation interlocking member 30 is a cylindrical member having a substantially cylindrical portion, and is radially regulated by fitting an inner circumferential surface 30a substantially radially to an outer circumferential surface 22c of the outer cylindrical body 22 in the main body 12, and is supported rotatably around the optical axis C1 along the outer circumferential surface 22c. That is, the rotation operation interlocking member 30 is disposed radially outside the lens drive member 28 around the optical axis C1, and surrounds the lens drive member 28 at intervals. In addition, the bayonet claw 22f protruding from the outer circumferential surface 22c of the outer cylindrical body 22 is substantially fitted into the bayonet groove 30e, so that the rotation operation interlocking member 30 is rotatably supported around the optical axis C1 in a state where the direction of the optical axis C1 is regulated. The rotation operation interlocking member 30 rotates by applying a rotational driving force to the outer circumferential surface by a manual operation by the user.

In the case of the present embodiment, the rotation operation interlocking member 30 rotates by directly applying a rotational driving force to the outer circumferential surface by a manual operation by the user, but the present embodiment is not limited thereto. Even if the rotational driving force by the manual operation is not directly applied to the rotation operation interlocking member 30, the manual operation member and the like are arranged on the further outer side or the inner side in the radial direction around the optical axis C1 of the rotation operation interlocking member 30 or the front side or the back side in the direction of the optical axis C1 of the rotation operation interlocking member 30, and the rotation operation interlocking member 30 is directly engaged with the manual operation member or indirectly engaged with the manual operation member via another member by key coupling or the like, so that both can be interlocked, and the rotational driving force can be applied from the manual operation member to the rotation operation interlocking member 30.

Further, the rotation operation interlocking member 30 is drivingly connected to the lens drive member 28 via a gear (rotating body) 32. In the case of the present embodiment, the gear (rotating body) 32 is a rotating body that rotates with its own rotation center line C2 parallel to the optical axis C1 as a central axis. The gear (rotating body) 32 is one of members for switching the rotation direction of the lens drive member 28 nearly around the optical axis C1, which is necessary for achieving the object of the present application. By switching the gear (rotating body) 32 from a rolling operation to be described later to a circling operation or vice versa, the rotation direction of the lens drive member 28 with respect to the rotation direction of the rotation operation interlocking member 30 is switched. When the gear (rotating body) 32 is switched to the rolling operation state, the lens drive member 28 rotates in the reverse direction (opposite direction) with respect to the rotation operation interlocking member 30. When the gear (rotating body) 32 is switched to the circling operation state, the lens drive member 28 rotates in the same direction with respect to the rotation operation interlocking member 30. As described above, when the rotation direction of the lens drive member 28 around the optical axis C1 is switched, the moving directions of the lens 16 and the lens 18 in the substantially extending direction (X-axis direction) of the optical axis C1 are switched.

An outer circumferential gear (outer circumferential rotation engagement portion) 28d is provided as an outer circumferential rotation engagement portion that is always engaged with the gear (rotating body) 32 in a portion of the outer circumferential surface 28c of the lens drive member 28 facing the gear (rotating body) 32. The outer circumferential rotation engagement portion includes friction engagement using contact friction, other than a gear engagement using a gear like an outer circumferential gear. In addition, an inner circumferential gear (inner circumferential rotation engagement portion) 30b is provided as an inner circumferential rotation engagement portion that is always engaged with the gear (rotating body) 32 in a portion of the inner circumferential surface 30a of the rotation operation interlocking member 30 facing the gear (rotating body) 32. The inner circumferential rotation engagement portion includes friction engagement using contact friction, other than a gear engagement using a gear such as an inner circumferential gear.

Regarding the gear (rotating body) 32, the outer circumferential gear (outer circumferential rotation engagement portion) 28d, and the inner circumferential gear (inner circumferential rotation engagement portion) 30b, the modules m of all the gears are the same in the case of the present embodiment. Since the lens drive member 28 is disposed on the radially inner side of the rotation operation interlocking member 30 around the optical axis C1, the outer circumferential gear (outer circumferential rotation engagement portion) 28d has a smaller pitch circle diameter and fewer teeth than the inner circumferential gear (inner circumferential rotation engagement portion) 30b. The gear (rotating body) 32 is a pinion gear having a smaller pitch circle diameter and fewer teeth than the outer circumferential gear (outer circumferential rotation engagement portion) 28d and the inner circumferential gear (inner circumferential rotation engagement portion) 30b.

In the case of the present embodiment, one gear (rotating body) 32 is always engaged with the inner circumferential gear (inner circumferential rotation engagement portion) 30b and the outer circumferential gear (outer circumferential rotation engagement portion) 28d in all the states of the rolling operation and the circling operation described later and the operation of transitioning (switching) between the two operations. Therefore, when the moving direction of the lens with respect to the rotation direction of the rotation operation interlocking member 30 rotationally operated by the user is switched from the front direction to the rear direction or vice versa, it is necessary to switch the state of the gear (rotating body) 32 from the rolling operation to the circling operation or from the circling operation to the rolling operation, but it is not necessary to provide a complicated switching mechanism that connects or disconnects the gear (rotating body) 32 with the inner circumferential gear (inner circumferential rotation engagement portion) 30b or the outer circumferential gear (outer circumferential rotation engagement portion) 28d. Since the gear (rotating body) 32 is always engaged with both the inner circumferential surface 30a of the rotation operation interlocking member 30 and the outer circumferential surface 28c of the lens drive member 28, the rotational driving force by the manual operation by the user is always transmitted from the rotation operation interlocking member 30 to the lens drive member 28 via the gear (rotating body) 32. In other words, in both the rolling operation and the circling operation described later, the rotational driving force by the manual operation by the user is transmitted from the rotation operation interlocking member 30 to the lens drive member 28 via the gear (rotating body) 32 without performing the operation by the complicated switching mechanism.

However, as described later, the rotation direction of the lens drive member 28 with respect to the rotation direction of the rotation operation interlocking member 30 is different between the rolling operation and the circling operation. In the rolling operation, both the rotation directions are opposite (reverse) directions, and in the circling operation, both the rotation directions are the same (positive) direction. This is because the gear (rotating body) 32 acts as an idle gear (idle rotating body) in a rolling operation, and a rotation direction between two gears (rotation engagement portions) engaged with each other with one idle gear (idle rotating body) interposed therebetween is opposite (reverse) to a rotation direction in a state where the gears are not interposed therebetween, and a reduction ratio, a speed increase ratio, or a gear ratio is the same as that in a state where the gears are directly connected to each other. In addition, when an odd number of rotating bodies are inserted therebetween, the direction of rotation of the driven-side rotation engagement portion with respect to the drive-side rotation engagement portion is changed as in the case of one rotating body.

In the case of the present embodiment, since the inner circumferential gear (inner circumferential rotation engagement portion) 30b of the rotation operation interlocking member 30 is an inner gear, the gear of the gear (rotating body) 32 is an outer gear, and the outer circumferential gear (outer circumferential rotation engagement portion) 28d of the lens drive member 28 is an outer gear, as the rotation direction, the gear (rotating body) 32 is in the same direction with respect to the rotation operation interlocking member 30, and the lens drive member 28 is opposite to the gear (rotating body) 32. Therefore, in the case of the present embodiment, the directions in which the outer circumferential gear (outer circumferential rotation engagement portion) 28d of the lens drive member 28 and the inner circumferential gear (inner circumferential rotation engagement portion) 30b of the rotation operation interlocking member 30 rotate are opposite (reverse) directions. The rotation direction of the outer circumferential gear (outer circumferential rotation engagement portion) 28d with respect to the inner circumferential gear (inner circumferential rotation engagement portion) 30b is the same (positive) direction in the rolling operation when a gear train (rotating body train) including an even number of gears (rotating bodies) is inserted therebetween, and thus the object of the present application cannot be achieved.

The idle gear referred to herein is an intermediate gear inserted between two transmission shafts, and is a gear including one type of gear in which the number of teeth in which teeth having the same tooth shape are arranged at an equal pitch on one pitch circle is determined. The idle gear plays a role of transmitting power transmitted from the drive gear to the driven gear, and the speed or rotation speed of the driven gear with respect to the drive gear, that is, the reduction ratio or the acceleration ratio or the gear ratio is not changed even when the idle gear is inserted between the transmission shafts. Also, insertion of one or an odd number of idle gears therebetween changes the direction of rotation of the driven gear relative to the drive gear.

The idle rotating body referred to herein is an intermediate rotating body inserted between two transmission shafts, and is a rotating body including one type of rotating body in which the circumferential length of the outer circumferential surface is determined. The idle rotating body plays a role of transmitting the power transmitted from the drive-side rotation engagement portion to the driven-side rotation engagement portion, and even if the idle rotating body is inserted between the transmission shafts, the speed or the rotation speed of the driven-side rotation engagement portion with respect to the drive-side rotation engagement portion, that is, the reduction ratio, the acceleration ratio, or the rotation speed ratio is not changed. In addition, when one or an odd number of idle rotating bodies are inserted therebetween, the direction of rotation of the driven-side rotation engagement portion with respect to the drive-side rotation engagement portion is changed.

In the present embodiment, the manual operation by the user is directly applied to rotation operation interlocking member 30, but the present embodiment is not limited thereto. There may be another member directly operated by the user, and the rotation operation interlocking member 30 may rotate in conjunction with the member. The same effects as those of the present embodiment can be obtained.

A gear (rotating body) support member 34 is a substantially annular member centered on the optical axis C1. The inner circumferential surface 34e is substantially radially fitted to the outer circumferential surface 20b of the inner cylindrical body 20 in the main body 12 to regulate the radial direction, and the gear (rotating body) support member is rotatably supported around the optical axis C1 along the outer circumferential surface 20b. In the case of the present embodiment, as illustrated in FIGS. 3 and 4, the gear (rotating body) supporting member 34 is arranged such that the position in the direction of the optical axis C1 is regulated in a state of being substantially sandwiched and fitted between the lens drive member 28 and a flange portion 20a of the inner cylindrical body 20 in the main body 12 in the substantially extending direction of the optical axis C1.

Specifically, the gear (rotating body) support member 34 includes an annular main body portion 34a that is disposed to be sandwiched between the inner cylindrical body 20 and the outer cylindrical body 22 in the main body 12 in the radial direction around the optical axis C1, a tongue piece portion 34b that protrudes from the main body portion 34a toward the outer diameter side (radially outside) around the optical axis C1, and a gear central axis portion 34d that protrudes from the tongue piece portion 34b in the substantially extending direction of the optical axis C1 to rotatably support the gear (rotating body) 32. The gear central axis portion 34d constitutes a rotation center line C2. At least a part of the gear (rotating body) 32 and the tongue piece portion 34b is disposed at substantially the same position as the outer cylindrical body 22 in the main body 12, that is, at a position interfering with each other in the radial direction around the optical axis C1.

Here, the rolling operation and the circling operation will be described. The gear (rotating body) 32 is rotatably supported about the rotation center line C2 by a gear central axis portion 34d of the gear support member 34 (rotating body support member). In other words, the gear (rotating body) 32 rotates around the rotation center line C2. The rolling operation of the gear (rotating body) 32 is a rotation operation in which the gear (rotating body) 32 rotates around its own rotation center line C2 as a rotation center axis. When the gear (rotating body) support member 34 rotates around the optical axis C1 with respect to the inner cylindrical body 20, the tongue piece portion 34b, the gear central axis portion 34d, and the rotation center line C2 also rotate around the optical axis C1, and the gear (rotating body) 32 rotates around the optical axis C1 together with them. In other words, the gear (rotating body) 32 revolves around the optical axis C1. The circling operation of the gear (rotating body) 32 is a revolving operation in which the gear (rotating body) 32 rotates around the optical axis C1 by rotating the rotation center line C2 of the gear (rotating body) 32 around the optical axis C1.

In the state of switching to the rolling operation, that is, in the state of permitting the rolling operation and regulating the circling operation, the gear (rotating body) 32 rotates (rotates) around the rotation center line C2, but does not rotate (revolve) around the optical axis C1. In this state, the gear (rotating body) 32 rolls relative to the outer circumferential gear (outer circumferential rotation engagement portion) 28d and the inner circumferential gear (inner circumferential rotation engagement portion) 30b. In the rolling state, the teeth of the outer circumferential gear (outer circumferential rotation engagement portion) 28d meshing with the teeth of the gear (rotating body) 32 and the teeth of the inner circumferential gear (inner circumferential rotation engagement portion) 30b sequentially move to the adjacent teeth.

In the state switched to the circling operation, that is, in the state in which the circling operation is permitted and the rolling operation is regulated, the gear (rotating body) 32 does not rotate (rotate) around the rotation center line C2, but rotates (revolves) around the optical axis C1. In this state, the gear (rotating body) 32 does not roll relative to the outer circumferential gear (outer circumferential rotation engagement portion) 28d and the inner circumferential gear (inner circumferential rotation engagement portion) 30b. In the non-rolling state, the teeth of the outer circumferential gear (outer circumferential rotation engagement portion) 28d and the teeth of the inner circumferential gear (inner circumferential rotation engagement portion) 30b that mesh with the teeth of the gear (rotating body) 32 do not move to the adjacent teeth, in other words, the teeth that mesh with each other do not change, and the same teeth continue to mesh with each other at all times. The gear (rotating body) 32 moves in a gear moving groove 22d in the state of the circling operation, that is, the gear moving groove 22d extends in the circumferential direction around the optical axis C1 as described above, so that the circling operation of circling around the optical axis C1 can be executed. The reason for this will be described later.

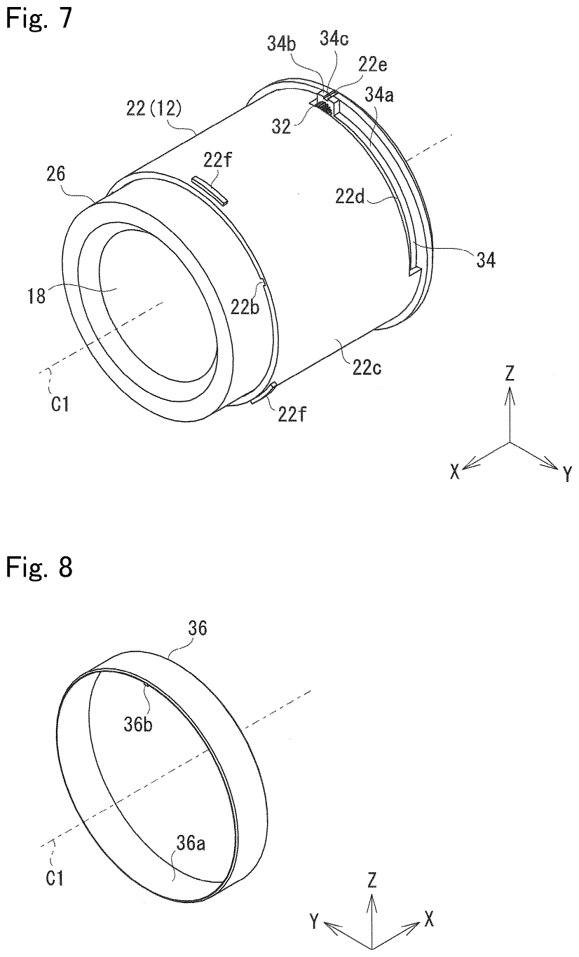

FIG. 7 is a perspective view of the lens barrel in a state where the rotation operation interlocking member 30 and a lens moving direction switching member 36 are removed as viewed obliquely from the front.

As described above, since at least a part of the gear (rotating body) 32 and the tongue piece portion 34b is disposed at a position that interferes with the outer cylindrical body 22 in the main body 12 in the radial direction, as illustrated in FIG. 7, the gear moving groove 22d as a clearance hole is formed in the outer cylindrical body 22 of the main body 12 so that the tongue piece portion 34b of the gear (rotating body) support member 34, the gear central axis portion 34d, and the gear (rotating body) 32 supported by the gear central axis portion 34d do not interfere with each other. Since the outer cylindrical body 22 needs to avoid the above-described interference regardless of whether the gear (rotating body) 32 is in the rolling operation or the circling operation, the gear moving groove 22d extends in the circumferential direction around the optical axis C1 over an angular range obtained by adding the size of the gear (rotating body) 32 and the tongue piece portion 34b to an angular range in which the gear (rotating body) 32 rotates nearly around the optical axis C1 for zooming (focal length change) at least by the circling operation, and is a hole penetrating in the radial direction around the optical axis C1.

With the gear moving groove 22d, the gear (rotating body) 32 can be engaged with both the inner circumferential gear (inner circumferential rotation engagement portion) 30b of the rotation operation interlocking member 30 located outside the outer cylindrical body 22 and the outer circumferential gear (outer circumferential rotation engagement portion) 28d of the lens drive member 28 located inside the outer cylindrical body 22 in either state of the rolling operation or the circling operation. That is, a portion on the outer side (outer diameter side around the optical axis C1) with respect to a portion of the gear (rotating body) 32 located in the gear moving groove 22d is engaged with the inner gear (inner circumferential rotation engagement portion) 30b of the rotation operation interlocking member 30, and a portion on the inner side (inner diameter side around the optical axis C1) is engaged with the outer circumferential gear (outer circumferential rotation engagement portion) 28d of the lens drive member 28.

As described above, the gear (rotating body) 32 can perform a rolling operation (rotation operation) of rolling (rolling) around the rotation center line C2 on the inner circumferential surface 30a of the rotation operation interlocking member 30 and the outer circumferential surface 28c of the lens drive member 28, and a circling operation (revolving operation) of circling around the optical axis C1 via the gear (rotating body) support member 34. As illustrated in FIGS. 1 to 6, in the case of the present embodiment, the lens barrel 10 includes the lens moving direction switching member 36 that switches the rotation direction of the lens drive member 28 with respect to the rotation direction of the rotation operation interlocking member 30 and switches the moving direction of the lenses 16 and 18 by permitting one of the rolling operation and the circling operation of the gear (rotating body) 32 and regulating the other.

In other words, the lens moving direction switching member 36 selectively switches between a state in which the gear (rotating body) 32 performs the rolling operation and a state in which the gear performs the circling operation. The lens barrel 10 includes a lens moving direction switching member 36 that switches from a state in which the rolling operation of the gear (rotating body) 32 is regulated and the circling operation is permitted to a state in which the rolling operation is permitted and the circling operation is regulated, or vice versa. The switching from the state in which only the rolling operation of the gear (rotating body) 32 is performed to the state in which only the circling operation is performed, or the switching in the reverse case is performed by the switching from the state in which the gear (rotating body) support member 34 does not rotate around the optical axis C1 to the state in which the gear (rotating body) support member rotates, or the switching in the reverse case according to the execution of the switching of the lens moving direction switching member 36.

Then, the gear (rotating body) support member 34 is substantially fixed to the outer cylindrical body 22 (main body 12) to be in a non-rotating state, and is fixed to the rotation operation interlocking member 30 to be in a rotating state. When the gear (rotating body) 32 is switched to the state of performing only the rolling operation by the lens moving direction switching member 36, the lens drive member 28 rotates in the reverse direction (opposite direction) with respect to the rotation direction of the rotation operation interlocking member 30. When the gear (rotating body) 32 is switched to the state of performing only the circling operation, the lens drive member 28 rotates in the normal direction (same direction) with respect to the rotation direction of the rotation operation interlocking member 30. When the rotation direction of the lens drive member 28 is switched, the moving directions of the lenses 16 and 18 are also switched.

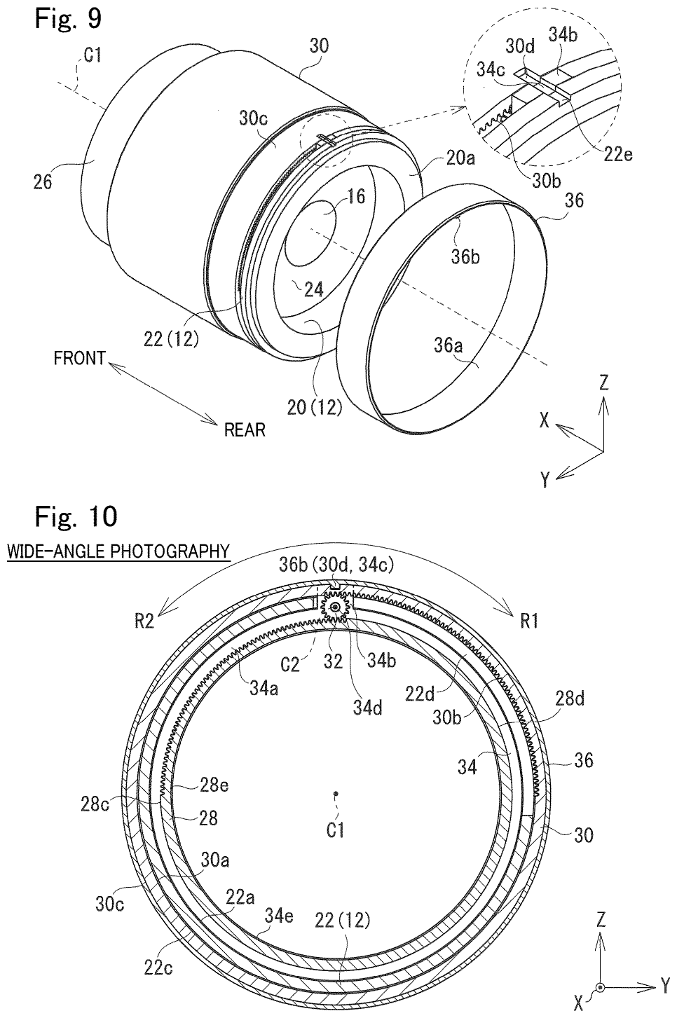

FIG. 8 is a perspective view of the lens moving direction switching member as viewed from an oblique rear side. FIG. 9 is a perspective view of the lens barrel in a state in which the lens moving direction switching member is removed when the wide-angle photographing (shortest optical system) is performed, as viewed from the oblique rear side.

In the case of the present embodiment, the lens moving direction switching member 36 is a cylindrical member having a substantially cylindrical portion, and is fitted substantially radially to the outer circumferential surface of a reduced diameter portion 30c on the rear end side of the rotation operation interlocking member 30, is rotatably supported around the optical axis C1 along the outer circumferential surface, and is movably supported in the substantially extending direction (X-axis direction) of the optical axis C1.

The lens moving direction switching member 36 can selectively connect (mutually substantially fixed, integrated, and integrally connected) the rotation operation interlocking member 30 or the outer cylindrical body 22 to the gear (rotating body) support member 34 in the rotation direction around the optical axis C1. By executing switching of the lens moving direction switching member 36, switching is performed from a state in which the rotation operation interlocking member 30 is coupled (substantially fixed to each other) or interlocked with the gear (rotating body) support member 34 to a state in which the outer cylindrical body 22 is coupled (substantially fixed to each other) or interlocked with the gear (rotating body) support member 34, or vice versa.

When the rotation operation interlocking member 30 is coupled (substantially fixed to each other) or interlocked with the gear (rotating body) support member 34, the gear (rotating body) support member 34 is in a state (rotatable state) of rotating around the optical axis C1 (with the optical axis C1 as a center), the circling operation is permitted, and the gear (rotating body) 32 supported by the gear (rotating body) support member 34 cannot roll with respect to the rotation operation interlocking member 30, that is, the rolling operation is regulated. When the outer cylindrical body 22 is coupled (substantially fixed to each other) or interlocked with the gear (rotating body) support member 34, a state (non-rotatable state) in which the gear (rotating body) support member 34 does not rotate around the optical axis C1 (with the optical axis C1 as a center) is obtained, the circling operation is regulated, and the gear (rotating body) 32 supported by the gear (rotating body) support member 34 can roll with respect to the rotation operation interlocking member 30, that is, the rolling operation is permitted.

More specifically, the gear (rotating body) support member 34 can substantially fix (integrated, engaged in immovable state) the rotation operation interlocking member 30 or the outer cylindrical body 22 selectively in the rotation direction (circumferential direction) around the optical axis C1. When the coupling (substantially fixed to each other) between the gear (rotating body) support member 34 and the rotation operation interlocking member 30 is selected by the lens moving direction switching member 36, the rolling operation (rotation operation) in which the gear (rotating body) 32 rotates with the rotation center line C2 (the center of the gear central axis portion 34d) as the central axis is regulated (not permitted), and the circling operation (revolving operation) in which the rotation center line C2 (the center of the gear central axis portion 34d) of the gear (rotating body) 32 rotates around the optical axis C1 is permitted (not regulated). When the coupling (substantially fixed to each other) between the gear (rotating body) support member 34 and the outer cylindrical body 22 is selected by the lens moving direction switching member 36, the rolling operation (rotation operation) in which the gear (rotating body) 32 rotates with the rotation center line C2 (the center of the gear central axis portion 34d) as the central axis is permitted (not regulated), and the circling operation (revolving operation) in which the rotation center line C2 (the center of the gear central axis portion 34d) of the gear (rotating body) 32 rotates around the optical axis C1 is regulated (not permitted).

In order to select the coupling (substantially fixed to each other) by the lens moving direction switching member 36, that is, perform the switching operation, as illustrated in FIG. 8, in the case of the present embodiment, the lens moving direction switching member 36 includes a key 36b extending in the substantially extending direction (X-axis direction) of the optical axis C1 on the inner circumferential surface 36a.

On the other hand, as illustrated in FIG. 9, key grooves 30d, 34c, and 22e that engage with the key 36b are formed in the rotation operation interlocking member 30, the gear (rotating body) support member 34, and the outer cylindrical body 22, respectively. Specifically, a key groove 30d is formed in the rotation operation interlocking member 30 so as to extend in the substantially extending direction (X-axis direction) of the optical axis C1 from the rear end of the outer circumferential surface (radially outward around the optical axis C1) of the reduced diameter portion 30c of the rotation operation interlocking member 30. In addition, the key groove 34c extending in the substantially extending direction of the optical axis C1 is formed at the tip on the outer diameter side (radially outer side) with the optical axis C1 as the center of the tongue piece portion 34b of the gear (rotating body) support member 34. In addition, the key groove 22e extending in the substantially extending direction of the optical axis C1 is formed on the outer diameter side (radially outer side) with the optical axis C1 as the center on the rear end side of the outer cylindrical body 22.

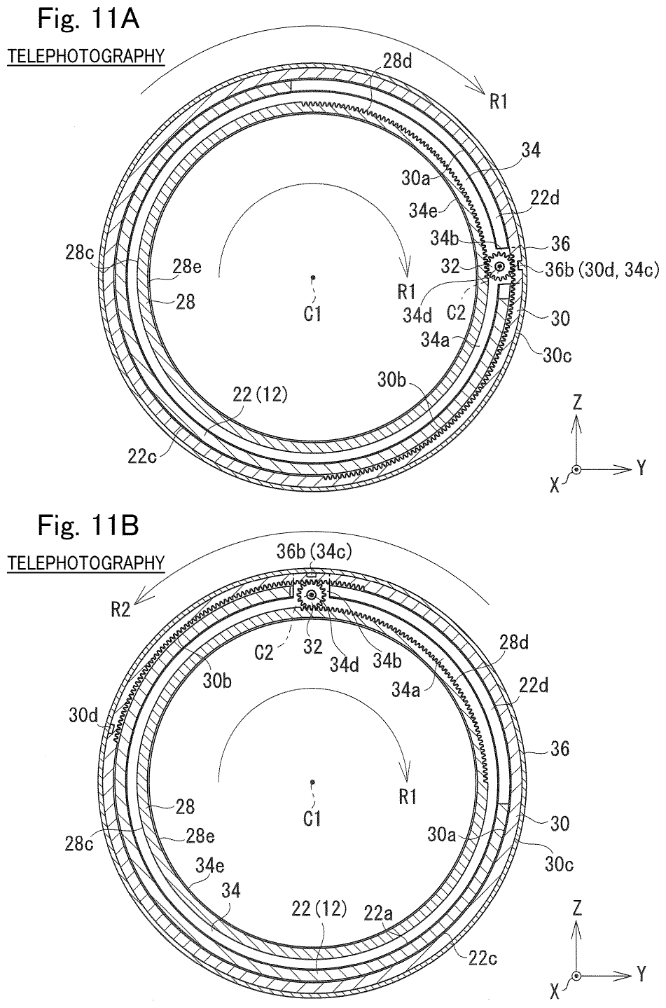

FIG. 10 is a cross-sectional view illustrating the positional relationship among the lens drive member 28, the rotation operation interlocking member 30, and the gear (rotating body) 32 in the wide-angle photographing (shortest optical system) state when viewed from the front of the lens barrel 10 (front view), that is, when the lens barrel 10 is viewed from the subject side. In the case of the present embodiment, the state at the time of wide-angle photographing is the state of the shortest optical system. FIG. 10 is a cross-sectional view taken along line A-A illustrated in FIG. 3. FIGS. 11A and 11B are cross-sectional views respectively illustrating the first and second positional relationships among the lens drive member 28, the rotation operation interlocking member 30, and the gear (rotating body) 32 in the telephotographing (longest optical system) state when viewed from the front of the lens barrel 10 (front view). In the case of the present embodiment, the state at the time of telephotographing is the state of the longest optical system.

In the present embodiment, as illustrated in FIG. 9, in the state at the time of wide-angle photographing, the key grooves 30d, 34c, and 22e of the rotation operation interlocking member 30, the gear (rotating body) support member 34, and the outer cylindrical body 22 are aligned in the substantially extending direction of the optical axis C1 (X-axis direction), that is, the positions of the grooves in the width direction (circumferential direction around optical axis C1) substantially coincide with each other. In this state, when the lens moving direction switching member 36 is switched and moved relatively to the front side (subject side) in the direction of the optical axis C1 with respect to the rotation operation interlocking member 30, the gear (rotating body) support member 34, or the outer cylindrical body 22, the key 36b of the lens moving direction switching member 36 is engaged with the key grooves 30d and 34c as illustrated in FIGS. 1, 3, and 10. That is, as a known key coupling, the key 36b is fitted in the key width direction (circumferential direction around the optical axis C1) with respect to the key grooves 30d and 34c to be coupled (substantially fixed to each other). In this state, the key 36b is not engaged with the key groove 22e. With this engagement, the rotation operation interlocking member 30 and the gear (rotating body) support member 34 are coupled (substantially fixed to each other) in the rotation direction (circumferential direction) around the optical axis C1, and can substantially integrally rotate around the optical axis C1.

Note that the key coupling in the technology of the present disclosure is used as a generic term for a method in which, in two objects, at least a part of one object has a convex shape and at least a part of the other object has a concave shape so as to match a key and a keyhole, and the convex portion and the concave portion are fitted to each other to couple the objects to each other. Therefore, the key coupling in the technology of the present disclosure is not limited to the shapes of the key and the key groove described in the present embodiment, and for example, a form in which a comb-tooth shape having a plurality of uneven shapes is formed in each of two objects, and the two objects mesh with each other by fitting the two comb-tooth shaped convex portions and the two comb-tooth shaped concave portions, and the two objects are coupled is also included in the key coupling described herein.

In the case of shifting from the state at the time of wide-angle photographing as illustrated in FIG. 1 to the state at the time of telephotographing as illustrated in FIG. 2, in the case of the present embodiment, in order to feed out the first and second lens support members 24 and 26 that support the lenses 16 and 18 in the substantially extending direction (X-axis direction) of the optical axis C1, it is necessary to operate the above-described cam mechanism by rotating the lens drive member 28 in the normal rotation direction R1 (clockwise direction) as viewed from the front of the lens barrel 10 (as viewed from the front) as illustrated in FIG. 10. In the state at the time of wide-angle photographing illustrated in FIGS. 1, 3, and 10, the lens moving direction switching member 36 is located on the relative front side (subject side) in the direction of the optical axis C1 by a manual operation by the user. When the rotation operation interlocking member 30 is rotated in the normal rotation direction R1 by the manual operation by the user, as illustrated in FIG. 11A, the lens drive member 28 also rotates in the normal rotation direction R1, and in the case of the present embodiment, the lenses 16 and 18 move in the forward direction.

Specifically, as illustrated in FIGS. 10 and 11A, in a state where the lens moving direction switching member 36 is operated to the front side (subject side) in the direction of the optical axis C1, and the rotation operation interlocking member 30 and the gear (rotating body) support member 34 are coupled (substantially fixed to each other) to each other by the lens moving direction switching member 36 by key coupling, the rolling operation of the gear (rotating body) 32 is regulated. In that state, the lens moving direction switching member 36 is not key-coupled to the outer cylindrical body 22, and the gear (rotating body) support member 34 and the outer cylindrical body 22 and the rotation operation interlocking member 30 and the outer cylindrical body 22 are not coupled (substantially fixed to each other), so that the gear (rotating body) 32 is permitted to perform the circling operation.

That is, when the lens moving direction switching member 36 is operated to the front side in the direction of the optical axis C1 (subject side), the gear (rotating body) support member 34 cannot rotate relative to the rotation operation interlocking member 30, that is, the gear (rotating body) support member 34 is coupled (substantially fixed to each other) to be substantially integrated, and can rotate with respect to the fixing portion (main body 12, outer cylindrical body 22). In that state, the gear (rotating body) 32 supported by the gear central axis portion 34d of the gear (rotating body) support member 34 and the inner circumferential gear (inner circumferential rotation engagement portion) 30b of the rotation operation interlocking member 30 are constantly meshed with the same teeth, and thus cannot roll (rolling operation) relative to each other. Further, since the rotation operation interlocking member 30 and the gear (rotating body) support member 34 are not coupled (substantially fixed to each other) to the outer cylindrical body 22, they can integrally rotate around the optical axis C1 in a state of being coupled (substantially fixed to each other) to each other.

The gear (rotating body) 32 meshes with not only the inner circumferential gear (inner circumferential rotation engagement portion) 30b of the rotation operation interlocking member 30 but also the outer circumferential gear (outer circumferential rotation engagement portion) 28d of the lens drive member 28, but cannot roll (rotate) with respect to the gear central axis portion 34d as described above. As a result, the gear (rotating body) 32 and the outer circumferential gear (outer circumferential rotation engagement portion) 28d also cannot roll (roll) relative to each other, and the gear (rotating body) 32 and the outer circumferential gear (outer circumferential rotation engagement portion) 28d are constantly meshed with the same teeth. In this state, the gear (rotating body) 32 cannot perform rolling (rotation) operation, but can perform circling (revolving) operation around the optical axis C1 integrally with the rotation operation interlocking member 30 and the gear (rotating body) support member 34. Therefore, when the rotation operation interlocking member 30 is rotated by the manual operation by the user, the gear (rotating body) 32 does not rotate (roll, rotate) with respect to the gear central axis portion 34d (rotation center line C2), and the rotational operation force is transmitted from the outer circumferential operation portion of the rotation operation interlocking member 30 to the lens drive member 28 via the inner circumferential gear (inner circumferential rotation engagement portion) 30b, the gear (rotating body) 32, and the outer circumferential gear (outer circumferential rotation engagement portion) 28d.

As a result, the lens drive member 28 can rotate around the optical axis C1 in the same rotation direction as the rotation operation interlocking member 30 in conjunction with the rotation operation interlocking member 30 in a state of being substantially radially fitted to the outer circumferential surface 20b of the inner cylindrical body 20. In this state, the respective gears, that is, the inner circumferential gear (inner circumferential rotation engagement portion) 30b and the gear (rotating body) 32, and the gear (rotating body) 32 and the outer circumferential gear (outer circumferential rotation engagement portion) 28d do not transmit forces by so-called gear drive that operates by rolling relative to each other, but do not roll relative to each other, and transmit forces only by engaging the gears with each other using the toothed uneven portions. In other words, the respective meshing gears do not transmit force from tooth to tooth while rolling, but transmit force from tooth to tooth without rolling.

When the rotation operation interlocking member 30 rotates in the normal rotation direction R1, the gear (rotating body) 32 circles (revolves) in the normal rotation direction R1 around the optical axis C1 without rotating (rolling, rotating) about the rotation center line C2 of the gear central axis portion 34d. In this state, the gear (rotating body) 32 does not roll and thus does not act as an intermediate gear such as an idle gear. Therefore, even if the gear (rotating body) 32 is sandwiched therebetween, the rotation direction of the outer circumferential gear (outer circumferential rotation engagement portion) 28d with respect to the inner circumferential gear (inner circumferential rotation engagement portion) 30b is not reversed and becomes the same direction. As a result, the lens drive member 28 engaged with the gear (rotating body) 32 via the outer circumferential gear (outer circumferential rotation engagement portion) 28d also rotates in the normal rotation direction R1, that is, in the same direction as the rotation operation interlocking member 30.

In a state where the lens moving direction switching member 36 is switched to the relative front side (subject side) in the direction of the optical axis C1 by the manual operation by the user, and the rotation operation interlocking member 30 and the gear (rotating body) support member 34 are coupled (substantially fixed to each other) by the key 36b being engaged with the key grooves 30d and 34c, when the rotation operation interlocking member 30 is rotated in the normal rotation direction R1 (clockwise direction) by the manual operation as illustrated in FIG. 11A, the lens drive member 28 rotates in the same direction, that is, the normal rotation direction R1 (clockwise direction). As a result, in the case of the present embodiment, when the lens drive member 28 rotates in the normal rotation direction R1 (clockwise direction), the lens barrel 10 transitions from the state on the wide-angle photographing (shortest optical system) side to the state on the telephotographing (longest optical system) side, the moving direction of the lens 16, 18 becomes the forward direction, and the first and second lens support members 24 and 26 extend in the substantially extending direction of the optical axis C1 with respect to the main body 12. As a result, the entire length of the lens barrel 10 in the substantially extending direction of the optical axis C1 extends.

In a state in which the lens moving direction switching member 36 is switched to the relative front side (subject side) in the direction of the optical axis C1, when the rotation operation interlocking member 30 is rotated in the normal rotation direction R1 (clockwise direction) and then rotated in the reverse rotation direction R2 by a manual inversion operation, the lens drive member 28 rotates in the same direction, that is, in the reverse rotation direction R2 (counterclockwise direction), the lens barrel 10 transitions from a state on the telephotographing (longest optical system) side to a state on the wide-angle photographing (shortest optical system) side, the moving direction of the lens 16, 18 becomes the back direction, and the first and second lens support members 24 and 26 withdraw in the substantially extending direction of the optical axis C1 with respect to the main body 12. As a result, the entire length of the lens barrel 10 in the substantially extending direction of the optical axis C1 decreases.

As described above, as illustrated in FIG. 9, in the state at the time of wide-angle photographing, the key grooves 30d, 34c, and 22e of the rotation operation interlocking member 30, the gear (rotating body) support member 34, and the outer cylindrical body 22 are aligned in the substantially extending direction (X-axis direction) of the optical axis C1, that is, the positions in the width direction (circumferential direction around the optical axis C1) of the grooves substantially coincide with each other. In this state, when the lens moving direction switching member 36 is switched and moved relatively to the back side (photographing surface side) in the direction of the optical axis C1 with respect to the rotation operation interlocking member 30, the gear (rotating body) support member 34, or the outer cylindrical body 22, the key 36b of the lens moving direction switching member 36 is engaged with the key grooves 34c and 22e. (A state in which the lens moving direction switching member 36 is moved to the photographing surface side from the state of FIGS. 1 and 3), that is, as a known key coupling, the key 36b is fitted in the key width direction (the circumferential direction around the optical axis C1) with respect to the key grooves 34c and 22e to be coupled (substantially fixed to each other). In this state, the key 36b is not engaged with the key groove 30d. With this engagement, the gear (rotating body) support member 34 and the outer cylindrical body 22 are coupled (substantially fixed to each other) to each other in the rotation direction (circumferential direction) around the optical axis C1. Since the outer cylindrical body 22 is a part of the main body 12 fixed to the lens mount, the gear (rotating body) support member 34 coupled (substantially fixed to each other) to the outer cylindrical body 22 is substantially fixed in a state of not being rotatable around the optical axis C1. In this case, the gear (rotating body) 32 is permitted to perform the rolling operation, and the circling operation is regulated. That is, the rotation of the rotation operation interlocking member 30 rotates the gear (rotating body) 32 around the rotation center line C2 of the gear central axis portion 34d.

More specifically, in a state where the lens moving direction switching member 36 is operated to the back side in the direction of the optical axis C1 (photographing surface side) from the states in FIGS. 10 and 11A, and the gear (rotating body) support member 34 and the outer cylindrical body 22 are coupled (substantially fixed to each other) to each other by the lens moving direction switching member 36 by key coupling, the circling operation (revolving operation) of the gear (rotating body) 32 around the optical axis C1 is regulated. In that state, since the lens moving direction switching member 36 is not key-coupled to the rotation operation interlocking member 30, the rotation operation interlocking member 30 and the gear (rotating body) support member 34, and the rotation operation interlocking member 30 and the outer cylindrical body 22 are not coupled (substantially fixed to each other), the gear (rotating body) 32 is permitted to perform the rolling operation with the gear central axis portion 34d or the rotation center line C2 as a center.

That is, when the lens moving direction switching member 36 is operated to the back side in the direction of the optical axis C1 (subject side), the gear (rotating body) support member 34 cannot rotate relative to the outer cylindrical body 22, that is, the gear (rotating body) support member 34 is coupled (substantially fixed to each other) to be substantially integrated, and can rotate relative to the rotation operation interlocking member 30. In that state, since the gear central axis portion 34d of the gear (rotating body) support member 34 is substantially integrally with the outer cylindrical body 22 and then not relatively rotatable around the optical axis C1, the gear (rotating body) 32 supported by the gear central axis portion 34d is not relatively rotatable (circling operation) around the optical axis C1. Further, since the rotation operation interlocking member 30 is not coupled (substantially fixed to each other) to each other to the gear (rotating body) support member 34 and the outer cylindrical body 22, the rotation operation interlocking member can relatively rotate around the optical axis C1.

When the rotation operation interlocking member 30 rotates around the optical axis C1 with respect to the gear (rotating body) support member 34, the inner circumferential gear (inner circumferential rotation engagement portion) 30b of the rotation operation interlocking member 30 also relatively rotates around the optical axis C1 along the gear central axis portion 34d of the gear (rotating body) support member 34. As a result, the gear (rotating body) 32 supported by the gear central axis portion 34d and having the teeth meshed with the inner circumferential gear (inner circumferential rotation engagement portion) 30b can roll (rolling) relatively to the inner circumferential gear (inner circumferential rotation engagement portion) 30b while sequentially moving the meshing portion to the adjacent teeth. In this state, the gear (rotating body) 32 cannot perform circling (revolving) operation, but can perform rolling (rotating) operation. Therefore, when the rotation operation interlocking member 30 is rotated by the manual operation by the user, the gear (rotating body) 32 rotates (rolls, rotates) with respect to the gear central axis portion 34d (rotation center line C2), and the rotational operation force is transmitted from the outer circumferential operation portion of the rotation operation interlocking member 30 to the lens drive member 28 via the inner circumferential gear (inner circumferential rotation engagement portion) 30b, the gear (rotating body) 32, and the outer circumferential gear (outer circumferential rotation engagement portion) 28d. In this state, since the gear (rotating body) 32 performs a rolling (rotating) operation, the rolling operation of relatively rolling also with respect to the outer circumferential gear (outer circumferential rotation engagement portion) 28d of the lens drive member 28 becomes possible.

As a result, the lens drive member 28 can rotate around the optical axis C1 in the reverse (opposite) rotation direction to the rotation operation interlocking member 30 in conjunction with the rotation operation interlocking member 30 in a state of being substantially radially fitted to the outer circumferential surface 20b of the inner cylindrical body 20. In this state, the respective gears, that is, the inner circumferential gear (inner circumferential rotation engagement portion) 30b and the gear (rotating body) 32, and the gear (rotating body) 32 and the outer circumferential gear (outer circumferential rotation engagement portion) 28d, rotate relative to each other to be actuated, and transmit the force by so-called gear drive. In other words, the respective meshing gears do not transmit force from tooth to tooth without rolling, but transmit force from tooth to tooth while rolling.

When the rotation operation interlocking member 30 rotates in the normal rotation direction R1, the gear (rotating body) 32 rotates (rolls, rotates) with the gear central axis portion 34d (rotation center line C2) as a center while stopping the rotation (circling operation) around the optical axis C1. Accordingly, the lens drive member 28 engaged with the gear (rotating body) 32 via the outer circumferential gear (outer circumferential rotation engagement portion) 28d rotates in the reverse rotation direction R2. That is, since the gear (rotating body) 32 rolls as described above, it acts as an intermediate gear such as an idle gear. In the case of the present embodiment, since the gear (rotating body) 32 is interposed as an idle gear, the rotation direction of the outer circumferential gear (outer circumferential rotation engagement portion) 28d is reversed with respect to the inner circumferential gear (inner circumferential rotation engagement portion) 30b and becomes the reverse direction (opposite direction).

The inner circumferential gear (inner circumferential rotation engagement portion) 30b that is an inner gear and the gear (rotating body) 32 that is an outer gear rotate in the same direction when being gear-driven with their teeth meshed with each other. In addition, the gear (rotating body) 32 which is an outer gear and the outer circumferential gear (outer circumferential rotation engagement portion) 28d which is an outer gear rotate in reverse (opposite) directions when being gear-driven in a state where the teeth are meshed with each other. Therefore, when the rotation operation interlocking member 30 rotates in the clockwise direction, the gear (rotating body) 32 rotates in the clockwise direction, and the lens drive member 28 rotates in the counterclockwise direction.

In a state where the lens moving direction switching member 36 is switched to the relative back side (photographing surface side) in the direction of the optical axis C1 by the manual operation by the user, and the gear (rotating body) support member 34 and the outer cylindrical body 22 are coupled (substantially fixed to each other) by the key 36b being engaged with the key grooves 34c and 22e, when the rotation operation interlocking member 30 is rotated in the reverse rotation direction R2 (counterclockwise direction) by the manual operation by the user as illustrated in FIG. 11B, the lens drive member 28 rotates in the opposite (reverse) direction, that is, the normal rotation direction R1 (clockwise direction). As a result, in the case of the present embodiment, when the lens drive member 28 rotates in the normal rotation direction R1 (clockwise direction), as described above, the lens barrel 10 transitions from the state on the wide-angle photographing (shortest optical system) side to the state on the telephotographing (longest optical system) side, the moving direction of lens 16, 18 becomes the forward direction, and the first and second lens support members 24 and 26 extend in the substantially extending direction of the optical axis C1 with respect to main body 12. As a result, the entire length of the lens barrel 10 in the substantially extending direction of the optical axis C1 extends.

When the rotation operation interlocking member 30 is rotated in the reverse rotation direction R2 (counterclockwise direction) and then rotated in the normal rotation direction R1 by a manual inversion operation in a state where the lens moving direction switching member 36 is switched to the relative back side (photographing surface side) in the direction of the optical axis C1, the lens drive member 28 rotates in the opposite (reverse) direction, that is, the reverse rotation direction R2 (counterclockwise direction), the lens barrel 10 transitions from the state on the telephotographing (longest optical system) side to the state on the wide angle photographing (shortest optical system) side, the moving direction of the lens 16, 18 becomes the back direction, and the first and second lens support members 24 and 26 withdraw in the substantially extending direction of the optical axis C1 with respect to the main body 12. As a result, the entire length of the lens barrel 10 in the substantially extending direction of the optical axis C1 decreases.

In the case of the present embodiment, the coupling (substantially fixed to each other) between the rotation operation interlocking member 30 and the gear (rotating body) support member 34 and the coupling (substantially fixed to each other) between the gear (rotating body) support member 34 and the outer cylindrical body 22 are performed by the above-described known key coupling, but the present embodiment is not limited thereto, and a method using frictional force may be used. In that case, when frictional force is applied between the lens moving direction switching member 36 and the rotation operation interlocking member 30, between the lens moving direction switching member 36 and the gear (rotating body) support member 34, and between the lens moving direction switching member 36 and the outer cylindrical body 22 to couple (substantially fixed and integrated with each other) and fix each other in the rotation direction (circumferential direction) around the optical axis C1, the same effects as those of the present embodiment can be obtained.

A method using this frictional force will be described in more detail. A part of the inner circumferential surface of the lens moving direction switching member 36 and a part of the outer circumferential surface of the rotation operation interlocking member 30 are arranged to face each other, and a tapered surface (conical surface) having an angle with respect to the optical axis C1 is formed on each of the inner circumferential surface and the outer circumferential surface facing each other. Furthermore, a tapered surface (conical surface) similar to the above is also formed on a part of the inner circumferential surface of the lens moving direction switching member 36 and a part of the outer circumferential surface of the outer cylindrical body 22. Further, a part of the inner circumferential surface of the lens moving direction switching member 36 and a part of the outer circumferential surface of the gear (rotating body) support member 34 are fitted so that the fitting portions always come into contact with each other to generate frictional force regardless of whether the position of the lens moving direction switching member 36 is front or rear side.

In this state, when the lens moving direction switching member 36 is moved forward, the tapered surface of the lens moving direction switching member 36 and the tapered surface of the rotation operation interlocking member 30 approach each other until they come into contact with each other, and when the tapered surfaces (conical surfaces) come into contact with each other, a frictional force is generated on the contact surface. A frictional force is always generated between the lens moving direction switching member 36 and the gear (rotating body) support member 34. As a result, the rotation operation interlocking member 30, the lens moving direction switching member 36, and the gear (rotating body) support member 34 are connected to each other by frictional force, and the rotation operation interlocking member 30 and the gear (rotating body) support member 34 are coupled (substantially fixed to each other). At this time, since the tapered surface of the lens moving direction switching member 36 and the tapered surface of the outer cylindrical body 22 are separated from each other and are not in contact with each other, no frictional force is generated. Therefore, the outer cylindrical body 22 and the gear (rotating body) support member 34 are not coupled (not fixed to each other).

Next, when the lens moving direction switching member 36 is moved backward, the tapered surface of the lens moving direction switching member 36 and the tapered surface of the outer cylindrical body 22 approach each other until they come into contact with each other, and when the tapered surfaces (conical surfaces) come into contact with each other, a frictional force is generated on the contact surface. A frictional force is always generated between the lens moving direction switching member 36 and the gear (rotating body) support member 34. As a result, the outer cylindrical body 22, the lens moving direction switching member 36, and the gear (rotating body) support member 34 are connected to each other by frictional force, and the outer cylindrical body 22 and the gear (rotating body) support member 34 are coupled (substantially fixed) to each other. At this time, since the tapered surface of the lens moving direction switching member 36 and the tapered surface of the rotation operation interlocking member 30 are separated from each other and are not in contact with each other, no frictional force is generated. Therefore, the rotation operation interlocking member 30 and the gear (rotating body) support member 34 are not coupled (not fixed to each other).

In the case of the method using the frictional force, since the key and the key groove do not exist, before the lens moving direction switching member 36 is switched, it is not necessary to align the key and the key groove by aligning the positions (rotation direction positions) in the circumferential direction with the optical axis C1 as the center of the rotation operation interlocking member 30, the gear (rotating body) support member 34, and the outer cylindrical body 22 with a constant position, and regardless of the positional relationship in the circumferential direction with the optical axis C1 as the center, the lens moving direction switching member 36 can be switched to either the front or rear side in the substantially extending direction (X-axis direction) of the optical axis C1. By doing so, regardless of which position or any state of the lens in the substantially extending direction of the optical axis, for example, regardless of the state of the wide-angle photographing, the state of the telephotographing, or any other state of the focal length, the lens moving direction switching member 36 can be switched to either the front or rear side in the substantially extending direction (X-axis direction) of the optical axis C1. When this embodiment is used as an example of the technology in the present disclosure, an effect that the user can perform the switching operation of the lens moving direction switching member 36 at an arbitrary timing is added in addition to the effect similar to the present embodiment.

As an example of the technology in the present disclosure, only the connection in the rotation direction between the lens moving direction switching member 36 and the gear (rotating body) support member 34 may be a key coupling, and the connection in the rotation direction between the lens moving direction switching member 36 and the rotation operation interlocking member 30 and the connection in the rotation direction between the lens moving direction switching member 36 and the outer cylindrical body 22 may employ a method using the above-described frictional force. In this embodiment, as compared with the case where the frictional force is used for all the connection portions as described above, an adjustment work of the frictional force generated between a part of the inner circumferential surface of the lens moving direction switching member 36 and the outer circumferential surface of the gear (rotating body) support member 34 becomes unnecessary. In addition, since the frictional force between the lens moving direction switching member 36 and the gear (rotating body) support member 34 is reduced, the operation force required for the switching operation for moving the lens moving direction switching member 36 to either the front or rear side can be reduced. When this embodiment is used as an example of the technology in the present disclosure, an effect that the user can perform the switching operation of the lens moving direction switching member 36 at an arbitrary timing with a small operation force is added in addition to the effect similar to the present embodiment.

As an example of the technology in the present disclosure, a method may be adopted in which only the connection in the rotation direction between the lens moving direction switching member 36 and the gear (rotating body) support member 34 is a key coupling, and the connection in the rotation direction between the lens moving direction switching member 36 and the rotation operation interlocking member 30, and the connection in the rotation direction between the lens moving direction switching member 36 and the outer cylindrical body 22 are formed by using a comb tooth shape having a plurality of uneven shapes in each of opposing portions of two members to be connected. In this embodiment, as compared with the case where the frictional force is used for all the connection portions as described above, all the adjustment work for generating the frictional force becomes unnecessary. In addition, since the frictional force at all the connection portions is reduced, the operation force required for the switching operation for moving the lens moving direction switching member 36 to either the front or rear side can be reduced. When this embodiment is used as an example of the technology in the present disclosure, an effect that the user can perform the switching operation of the lens moving direction switching member 36 at an arbitrary timing with a small operation force is added in addition to the effect similar to the present embodiment.

Further, in the case of the present embodiment, the respective key couplings of the coupling (substantially fixed to each other) of the rotation operation interlocking member 30 and the gear (rotating body) support member 34 and the coupling (substantially fixed to each other) of the gear (rotating body) support member 34 and the outer cylindrical body 22 are configured by one key and one key groove in the circumferential direction around the optical axis C1, but the present embodiment is not limited thereto. In the circumferential direction, a plurality of keys and a plurality of key grooves may constitute a key coupling. The same effects as those of the present embodiment can be obtained.

Further, in the case of the present embodiment, in the wide-angle photographing state, the key grooves 30d, 34c, and 22e of the rotation operation interlocking member 30, the gear (rotating body) support member 34, and the outer cylindrical body 22 are aligned in the substantially extending direction (X-axis direction) of the optical axis C1, that is, the positions in the width direction (circumferential direction around the optical axis C1) of the grooves substantially coincide with each other, but the present embodiment is not limited thereto. The key grooves 30d, 34c, and 22e may be aligned in the substantially extending direction (X-axis direction) of the optical axis C1 in any of the telephotographing state other than the wide-angle photographing state and the other focal length state. The same effects as those of the present embodiment can be obtained.

Further, in the case of the present embodiment, in the wide-angle photographing state, the key grooves 30d, 34c, and 22e of the rotation operation interlocking member 30, the gear (rotating body) support member 34, and the outer cylindrical body 22 are aligned in the substantially extending direction (X-axis direction) of the optical axis C1, that is, the positions in the width direction (circumferential direction around the optical axis C1) of the grooves substantially coincide with each other, but the present embodiment is not limited thereto. The key grooves 30d, 34c, and 22e may be aligned in the substantially extending direction (X-axis direction) of the optical axis C1 in the states of the plurality of focal lengths in which the state of the wide-angle photographing, the state of the telephotographing, and other states of the focal length are added. The same effects as those of the present embodiment can be obtained.

In this case, when the number of the key grooves 30d and 22e that can be engaged with one key 36b is sufficiently large in the circumferential direction around the optical axis C1, the lens moving direction switching member 36 can be switched from the front side to the rear side in the approximately extending direction (X-axis direction) of the optical axis C1 or vice versa in approximately any focal length state or approximately anywhere in the substantially extending direction (X-axis direction) of the optical axis C1. Since the key groove 34c is always engaged with the key 36b at any switching position on the front side or the rear side in the substantially extending direction (X-axis direction) of the optical axis C1 of the lens moving direction switching member 36, a large number of key grooves may not be arranged in the circumferential direction around the optical axis C1. By using this embodiment as an example of the technology in the present disclosure, the user can perform the switching operation of the lens moving direction switching member 36 at an arbitrary timing.

In addition, in the case of the present embodiment, the number of the tongue piece portions 34b of the gear (rotating body) support member 34 is one (one place) in the circumferential direction around the optical axis C1, but the present embodiment is not limited thereto, and a plurality of tongue piece portions may be provided in the circumferential direction. In that case, the coupling (substantially fixed to each other) between the rotation operation interlocking member 30 and the gear (rotating body) support member 34 and the coupling (substantially fixed to each other) between the gear (rotating body) support member 34 and the outer cylindrical body 22 can be performed at a plurality of places in accordance with the positions of the plurality of tongue piece portions 34b. In addition, a plurality of gear central axis portions 34d constituting the rotation center line C2 can also be provided in accordance with the positions of the plurality of tongue piece portions 34b, and a plurality of gears (rotating bodies) 32 and a plurality of inner circumferential rotation engagement portions of the rotation operation interlocking member 30 engaged therewith and a plurality of outer circumferential rotation engagement portions of the lens drive member 28 can also be provided in accordance with the positions of the gear central axis portions 34d. The same effects as those of the present embodiment can be obtained.

In addition, in the case of the present embodiment, the gear (rotating body) 32 sandwiched between the inner circumferential gear (inner circumferential rotation engagement portion) 30b of the rotation operation interlocking member 30 and the outer circumferential gear (outer circumferential rotation engagement portion) 28d of the lens drive member 28 and engaged with both is constituted by one idle gear (idle rotating body), and a speed reduction ratio, a speed increase ratio, or a gear ratio of the inner circumferential gear (inner circumferential rotation engagement portion) 30b and the outer circumferential gear (outer circumferential rotation engagement portion) 28d sandwiching the gear (rotating body) 32 is the same as a state in which both are directly connected to each other, but the present embodiment is not limited thereto. The gear (rotating body) 32 may be constituted by one two-stage gear (two-stage rotating body), and a speed reduction ratio, a speed increase ratio, or a gear ratio of the inner circumferential gear (inner circumferential rotation engagement portion) 30b and the outer circumferential gear (outer circumferential rotation engagement portion) 28d may be changed from a state in which both are directly connected.

The idle gear referred to herein is an ordinary gear including one gear having a fixed number of teeth, and plays a role of transmitting the power transmitted from the drive gear to the driven gear, and even if the idle gear is inserted therebetween, the speed or rotation speed of the driven gear with respect to the drive gear, that is, the speed reduction ratio or the speed increase ratio is not changed. In addition, when one idle gear is inserted therebetween, the direction of rotation of the driven gear with respect to the drive gear is changed.

The idle rotating body referred to herein is a rotating body including one rotating body having a fixed circumferential length of the outer circumferential surface, and plays a role of transmitting the power transmitted from the drive-side rotation engagement portion to the driven-side rotation engagement portion, and even if the idle rotating body is inserted therebetween, the speed or the rotation speed of the driven-side rotation engagement portion with respect to the drive-side rotation engagement portion, that is, the speed reduction ratio or the speed increase ratio is not changed. In addition, when one idle rotating body is inserted therebetween, the direction of rotation of the driven gear with respect to the drive gear is changed.

The two-stage gear referred to herein is a gear in which the first gear and the second gear having a larger pitch circle diameter than the first gear and having a larger number of teeth are adjacent to each other along the rotation axis in a state where the rotation centers of the first gear and the second gear are aligned, and the two gears are integrated. The two-stage gear plays a role of transmitting the power transmitted from the drive gear to the driven gear and, when inserted therebetween, changes the speed or the rotation speed of the driven gear with respect to the drive gear, that is, the speed reduction ratio or the speed increase ratio or the gear ratio.

The two-stage rotating body referred to herein is a rotating body in which a first rotating body and a second rotating body having a longer circumferential length of an outer circumferential surface than that of the first rotating body are adjacent to each other along a rotation axis in a state where rotation centers of the first rotating body and the second rotating body are aligned, and the two rotating bodies are integrated. The two-stage rotating body plays a role of transmitting the power transmitted from the drive-side rotation engagement portion to the driven-side rotation engagement portion, and when inserted therebetween, a speed or a rotation speed of the driven-side rotation engagement portion with respect to the drive-side rotation engagement portion, that is, a speed reduction ratio, a speed increase ratio, or a rotation speed ratio is changed. For transmission of the rotational driving force between the rotating bodies, frictional force, magnetic force, electric force, adhesive force, or the like acting between the rotating bodies is used.

In the case of the present embodiment, since the pitch circle of the inner circumferential gear (inner circumferential rotation engagement portion) 30b of the rotation operation interlocking member 30 is larger in diameter than the pitch circle of the outer circumferential gear (outer circumferential rotation engagement portion) 28d of the lens drive member 28, when a rolling operation is performed with the gear (rotating body) 32 as an idle gear (idle rotating body) interposed therebetween, the rotation angle around the optical axis C1 is larger in the lens drive member 28 than in the rotation operation interlocking member 30. When the idle gear (idle rotating body) is replaced with a two-stage gear (two-stage rotating body), the rotation angles around the optical axis C1 of the rotation operation interlocking member 30 and the lens drive member 28 can be corrected to be substantially the same. More specifically, the above correction becomes possible by engaging the first gear (small pitch circle diameter, few teeth) of the two-stage gear with the outer circumferential gear (outer circumferential rotation engagement portion) 28d of the lens drive member 28 and engaging the second gear (large pitch circle diameter, large number of teeth) with the inner circumferential gear (inner circumferential rotation engagement portion) 30b of the rotation operation interlocking member 30.

Specifically, for example, in a case where the idle gear is replaced with a two-stage gear, the rotation angle around the optical axis C1 can be corrected by setting the following conditions.

In a case where the idle gear is sandwiched therebetween, under the condition that the inner circumferential gear 30b of the rotation operation interlocking member 30 has the pitch circle diameter D30, the module m, and the number of teeth Z30=D30/m, the outer circumferential gear 28d of the lens drive member 28 has the pitch circle diameter D28, the module m, and the number of teeth Z28-D28/m, and the idle gear has the pitch circle diameter D32, the module m, and the number of teeth Z32=D32/m, the relationship between the angle of rotation θ30 of the rotation operation interlocking member 30 around the optical axis C1 and the angle of rotation θ28 of the lens drive member 28 is the relationship shown in Equation 1.

[Equation 1]

θ28=θ30×(D30/D28)=θ30×(Z30/Z28) (Equation 1)

In a case where the two-stage gear is sandwiched therebetween, under the conditions that the inner circumferential gear 30b of the rotation operation interlocking member 30 has the pitch circle diameter D30, the module m, and the number of teeth Z30=D30/m, the outer circumferential gear 28d of the lens drive member 28 has the pitch circle diameter D28, the module m, and the number of teeth Z28=D28/m, the first gear (small pitch circle diameter, few teeth) of the two-stage gear has the pitch circle diameter D321, the module m, and the number of teeth Z321=D321/m, and the second gear (large pitch circle diameter, large number of teeth) of the two-stage gear has the pitch circle diameter D322, the module m, and the number of teeth Z322=D322/m, the relationship between the angle of rotation θ30 of the rotation operation interlocking member 30 around the optical axis C1 and the angle of rotation θ28 of the lens drive member 28 is the relationship shown in Equations 2 and 3.

[Equation 2]

θ28=θ30×(D30/D28)×(D321/D322) (Equation 2)

[Equation 3]

θ28=θ30×(Z30/Z28)×(Z321/Z322) (Equation 3)

Therefore, the condition of θ28=θ30 is (D30/D28)×(D321/D322)=1 or (Z30/Z28)×(Z321/Z322)=1. When these are rewritten, D30/D28=D322/D321 or Z30/Z28=Z322/Z321 is obtained.

As described above, in a case where the idle gear is sandwiched therebetween, with respect to the angle of rotation θ30 of the rotation operation interlocking member 30, the angle of rotation θ28 of the lens drive member 28 increases according to the ratio of the pitch circle diameter or the ratio of the number of teeth, but in a case where the two-stage gear is sandwiched therebetween, the angle of rotation θ28 of the lens drive member 28 with respect to the angle of rotation θ30 of the rotation operation interlocking member 30 is corrected according to the ratio of the pitch circle diameter or the ratio of the number of teeth of the first gear and the second gear of the two-stage gear, so that the rotation angle difference between the two can be reduced.

If the above-described condition that θ28=θ30 of the two-stage gear is adopted, even when the lens moving direction with respect to the rotation direction of the rotation operation interlocking member 30 is switched by operating the lens moving direction switching member 36, the rotation angle of the rotation operation interlocking member 30 for moving the lens over the entire moving range (from wide angle to telephoto in the case of zooming) does not change. As a result, the user can perform a rotation operation without feeling uncomfortable even when the lens moving direction is switched.

Of course, it is not necessary to strictly apply the condition of θ28=θ30, for example, Z30/Z28=Z322/Z321. It may be set so as to approximate these conditions, substantially become these conditions, or approach these conditions. That is, when the first gear is engaged with the outer circumferential gear (the outer circumferential rotation engagement portion) 28d of the lens drive member 28 and the second gear is engaged with the inner circumferential gear (the inner circumferential rotation engagement portion) 30b of the rotation operation interlocking member 30 using the two-stage gear which is a gear in which the first gear (small pitch circle diameter, few teeth) and the second gear (large pitch circle diameter, large number of teeth) having a larger pitch circle diameter than the first gear and a larger number of teeth are integrated, the same effect can be obtained even if Z30/Z28=Z322/Z321 is not strictly satisfied.

Furthermore, for example, in a case where the idle rotating body is replaced with a two-stage rotating body, the above-described correction becomes possible by engaging the first rotating body (having a short circumferential length of the outer circumferential surface) of the two-stage rotating body with the outer circumferential rotation engagement portion 28d of the lens drive member 28 and engaging the second rotating body (having a long circumferential length of the outer circumferential surface) with the inner circumferential rotation engagement portion 30b of the rotation operation interlocking member 30.

Specifically, for example, when the following conditions are set, the rotation angle around the optical axis C1 can be corrected.

In a case where the idle rotating body is sandwiched therebetween, under the conditions that the inner circumferential rotation engagement portion of the rotation operation interlocking member 30 has an inner circumferential circle diameter DD30 and an inner circumferential length DC30, the outer circumferential rotation engagement portion of the lens drive member 28 has an outer circumferential circle diameter DD28 and an outer circumferential length DC28, and the outer circumferential engagement portion of the idle rotating body has an outer circumferential circle diameter DD32 and an outer circumferential length DC32, the relationship between the angle of rotation θ30 of the rotation operation interlocking member 30 around the optical axis C1 and the angle of rotation θ28 of the lens drive member 28 is the relationship shown in Equation 4.

[Equation 4]

θ28=θ30×(DD30/DD28)=θ30×(DC30/DC28) (Equation 4)

In a case where the two-stage rotating body is sandwiched therebetween, under the conditions that the inner circumferential rotation engagement portion of the rotation operation interlocking member 30 has an inner circumferential circle diameter DD30 and an inner circumferential length DC30, the outer circumferential rotation engagement portion of the lens drive member 28 has an outer circumferential circle diameter DD28 and an outer circumferential length DC28, the outer circumferential engagement portion of the first rotating body (small outer circumferential diameter, short outer circumferential length) of the two-stage rotating body has an outer circumferential circle diameter DD321 and an outer circumferential length DC321, and the outer circumferential engagement portion of the second rotating body (large outer circumferential diameter, long outer circumferential length) of the two-stage rotating body has an outer circumferential circle diameter DD322 and an outer circumferential length DC322, the relationship between the angle of rotation θ30 of the rotation operation interlocking member 30 around the optical axis C1 and the angle of rotation θ28 of the lens drive member 28 is the relationship shown in Equations 5 and 6.

[Equation 5]

θ28=θ30×(DD30/DD28)×(DD321/DD322) (Equation 5)

[Equation 6]

θ28=θ30×(DC30/DC28)×(DC321/DC322) (Equation 6)

Therefore, the condition of θ28=θ30 is (DD30/DD28)× (DD321/DD322)=1 or (DC30/DC28)× (DC321/DC322)=1, and when these are rewritten, DD30/DD28=DD322/DD321 is obtained.

In addition, by using a two-stage rotating body which is a rotating body in which the first rotating body (the circumferential length of the outer circumferential surface is short) and the second rotating body (the circumferential length of the outer circumferential surface is long) having a longer circumferential length of the outer circumferential surface than the first rotating body are integrated when the first rotating body is engaged with the outer circumferential rotation engagement portion 28d of the lens drive member 28 and the second rotating body is engaged with the inner circumferential rotation engagement portion 30b of the rotation operation interlocking member 30 a similar effect can be obtained even if DD30/DD28=DD322/DD321 is not strictly satisfied.

In the case of the present embodiment, the number of gears (rotating bodies) 32 to be engaged with the inner circumferential gear (inner circumferential rotation engagement portion) 30b of the rotation operation interlocking member 30 and the outer circumferential gear (outer circumferential rotation engagement portion) 28d of the lens drive member 28 is one, but the present embodiment is not limited thereto, and a gear train (rotating body train) including a plurality of odd number of gears (rotating bodies) 32 may be used. When a gear train (rotating body train) including an odd number of gears (rotating bodies) including one is inserted therebetween, the direction of rotation of the outer circumferential gear (outer circumferential rotation engagement portion) 28d with respect to the inner circumferential gear (inner circumferential rotation engagement portion) 30b is changed. Therefore, even with a configuration in which a gear train (rotating body train) including an odd number of gears (rotating bodies) 32 whose adjacent members are engaged with each other is sandwiched between the outer circumferential gear (outer circumferential rotation engagement portion) 28d in the portion of the outer circumferential surface of the lens drive member 28 and the inner circumferential gear (inner circumferential rotation engagement portion) 30b in the portion of the inner circumferential surface of the rotation operation interlocking member 30, the same effects as those of the present embodiment can be obtained.

In addition, in the case of the embodiment described above, the gear (rotating body) 32 includes an odd number of idle gears (idle rotating body), and the gear ratio or the rotation speed ratio between the two gears (rotation engagement portions) engaged with each other with the odd number of gears (rotating bodies) 32 sandwiched therebetween, that is, the inner circumferential gear (inner circumferential rotation engagement portion) 30b of the rotation operation interlocking member 30 and the outer circumferential gear (outer circumferential rotation engagement portion) 28d of the lens drive member 28 in the present embodiment is the same as that in a state where the two gears are directly connected to each other, but the gear ratio or the rotation speed ratio is not limited thereto. The odd number of gears (rotating bodies) 32 may include one or more two-stage gears (two-stage rotating bodies). The two-stage gear referred to herein (two-stage rotating body) is as described above.

One of the outer circumferential gear (outer circumferential rotation engagement portion) 28d and the inner circumferential gear (inner circumferential rotation engagement portion) 30b is engaged with the first gear (first rotating body) formed in one of one or a plurality of two-stage gears (two-stage rotating body), the other of the outer circumferential gear (outer circumferential rotation engagement portion) 28d and the inner circumferential gear (inner circumferential rotation engagement portion) 30b is engaged with the second gear (second rotating body) formed in one of one or a plurality of two-stage gears (two-stage rotating body), and in a state where the one or a plurality of two-stage gears (two-stage rotating body) is engaged, the gear ratio or the rotation speed ratio of the outer circumferential gear (outer circumferential rotation engagement portion) 28d or the inner circumferential gear (inner circumferential rotation engagement portion) 30b may be different from that in a state where the both are directly connected. In this case, the angle of rotation θ28 of the lens drive member 28 with respect to the angle of rotation θ30 of the rotation operation interlocking member 30 is corrected on the basis of the idea of the known two-stage gear speed reduction (speed increase) mechanism according to the ratio of the pitch circle diameter or the ratio of the number of teeth or the ratio of the circumferential length of the outer circumferential surface of the first gear (first rotating body) and the second gear (second rotating body) of each of the plurality of two-stage gears (two-stage rotating body).

In the case of the above-described embodiment, when the first gear (first rotating body) formed in the two-stage gear (two-stage rotating body) and having a small pitch diameter is engaged with the outer circumferential gear (outer circumferential rotation engagement portion) 28d or the inner circumferential gear (inner circumferential rotation engagement portion) 30b, the second gear (second rotating body) adjacent to the first gear (first rotating body) and having a large pitch diameter or a long circumferential length of the outer circumferential surface first interferes with the outer circumferential gear (outer circumferential rotation engagement portion) 28d or the inner circumferential gear (inner circumferential rotation engagement portion) 30b.

In order to avoid this interference, as a first method, a recess (thinned portion, escape portion) larger than the interference amount in the direction of the optical axis C1 and the radial direction, that is, avoiding the outer shape of the second gear (second rotating body) may be provided in the outer diameter portion of the outer circumferential gear (outer circumferential rotation engagement portion) 28d or the inner diameter portion of the inner circumferential gear (inner circumferential rotation engagement portion) 30b which is at a position facing and interfering with the second gear (second rotating body).

As a second method, one or a plurality of idle gears (idle rotating bodies) may be added and sandwiched between the first gear (first rotating body) and the outer circumferential gear (outer circumferential rotation engagement portion) 28d or the inner circumferential gear (inner circumferential rotation engagement portion) 30b while being engaged as one portion of the gear train (rotating body train). Even in this case, since the number of gear trains (rotating body trains) sandwiched while being engaged between the outer circumferential gear (outer circumferential rotation engagement portion) 28d and the inner circumferential gear (inner circumferential rotation engagement portion) 30b needs to be an odd number, as a minimum number, another idle gear (idle rotating body) or a two-stage gear (idle rotating body) may be added in addition to the two-stage gear (two-stage rotating body) and the idle gear (idle rotating body) for avoiding interference, and the three gears (rotating bodies) may be sandwiched between the gear trains (rotating body trains).

As described above, in a case where the state at the time of wide-angle photographing (shortest optical system) illustrated in FIG. 1 is shifted to the state at the time of telephotographing (longest optical system) illustrated in FIG. 2, according to the switching state of the lens moving direction switching member 36, by permitting either the rolling operation or the circling operation of the gear (rotating body) 32 and regulating the other, in other words, by switching from the state in which the rolling operation of the gear (rotating body) 32 is regulated and the circling operation is permitted to the state in which the rolling operation is permitted and the circling operation is regulated, or vice versa, even if the rotation operation interlocking member 30 is rotated in either the normal rotation direction R1 or the reverse rotation direction R2, the lens drive member 28 is rotated in the normal rotation direction R1 to shift from the state at the time of wide-angle photographing illustrated in FIG. 1 to the state at the time of telephotographing illustrated in FIG. 2, that is, it is possible to drive in the same zoom direction (changing direction of the focal length). Similarly, even if the rotation operation interlocking member 30 is rotated in either the normal rotation direction R1 or the reverse rotation direction R2, the state of the shortest optical system illustrated in FIG. 1 can be shifted to the state of the longest optical system illustrated in FIG. 2, that is, the lenses 16 and 18 can be driven in the same moving direction (extending direction).

Furthermore, also in a case of shifting from the state at the time of telephotographing illustrated in FIG. 2 to the state at the time of wide-angle photographing illustrated in FIG. 1, similarly, by switching the lens moving direction switching member 36, the lens drive member 28 can be rotated in the reverse rotation direction R2 regardless of whether the rotation operation interlocking member 30 is rotated in the normal rotation direction R1 or the reverse rotation direction R2, and the state at the time of telephotographing (longest optical system) illustrated in FIG. 2 can be shifted to the state at the time of wide-angle photographing (shortest optical system) illustrated in FIG. 1, that is, the lenses 16 and 18 can be driven in the same moving direction (withdrawing direction).

In other words, the user switches the rotation direction of the lens drive member 28 with respect to the rotation direction of the rotation operation interlocking member 30 by the switching operation according to preference, and switches the moving direction of the lens 16, 18 from the front direction to the rear direction or vice versa, so that it is possible to switch the focal length changing direction (zoom direction), that is, the direction from the direction toward the telephotographing to the wide-angle photographing (magnification enlargement direction to magnification reduction direction) or vice versa.

Note that, in a case where the gear (rotating body) support member 34 does not rotate even if the rotation operation interlocking member 30 is rotated in a state in which the coupling (substantially fixed to each other) with the gear (rotating body) support member 34 is released due to a frictional force, a magnetic force, an electric force, an adhesive force, or the like between the gear (rotating body) support member 34 and the outer circumferential surface 20b of the inner cylindrical body 20 in the main body 12 supporting the gear (rotating body) support member, since the outer cylindrical body 22, the gear (rotating body) support member 34 and the outer cylindrical body 22 in the main body 12 are substantially fixed by a frictional force, a magnetic force, an electric force, an adhesive force, or the like via the inner cylindrical body 20, a coupling means that can be selected to be fixed or released as in the key coupling or the like can be omitted.

Similarly, in a case where due to frictional force, magnetic force, electric force, adhesive force, or the like between the gear (rotating body) 32 and the gear central axis portion 34d of the gear (rotating body) support member 34 supporting the gear (rotating body), the gear (rotating body) support member 34 rotates in conjunction with the gear (rotating body) 32 even if the rotation operation interlocking member 30 is rotated in a state in which the coupling (substantially fixed to each other) between the outer cylindrical body 22 and the gear (rotating body) support member 34 in the main body 12 is released, since the rotation operation interlocking member 30 and the gear (rotating body) support member 34 are substantially fixed by frictional force, magnetic force, electric force, adhesive force, or the like, the coupling (substantially fixed to each other) that can be selected to be fixed or released as in a key coupling or the like can be omitted. In other words, as a method of regulating any one of the rotation, that is, the circling operation, around the optical axis C1 of the gear (rotating body) support member 34, and the rotation, that is, the rolling operation, around the gear central axis portion 34d or the rotation center line C2 of the gear (rotating body) 32, a coupling means such as a frictional force, a magnetic force, an electric force, or an adhesive force, which cannot be selected to be fixed or released, can be used.

Therefore, in the case of the present embodiment, when the lens moving direction switching member 36 moves forward (subject side), the key 36b is engaged with the key groove 30d of the rotation operation interlocking member 30 and the key groove 34c of the gear (rotating body) support member 34, and when the lens moving direction switching member 36 moves backward (photographing surface side), the key 36b is engaged with the key groove 34c of the gear (rotating body) support member 34 and the key groove 22e of the outer cylindrical body 22. That is, when the lens moving direction switching member 36 moves forward (subject side), the rolling operation of the gear (rotating body) 32 is regulated and the circling operation is permitted, and when the lens moving direction switching member 36 moves backward (photographing surface side), the rolling operation of the gear (rotating body) 32 is permitted and the circling operation is regulated. Furthermore, in the case of the above-described another embodiment as an example of the technology in the present disclosure, the movement to a front side or a back side of the lens moving direction switching member 36 can be performed by the user at any timing. That is, the lens moving direction switching member 36 can be moved to a front side or a back side regardless of the relative positions of the lens drive member 28, the rotation operation interlocking member 30, and the gear (rotating body) 32.

According to the plurality of embodiments as described above, in the lens barrel, it is possible to switch the moving direction of the lens with respect to the rotation direction of the rotation operation interlocking member manually rotated by the user from the front direction to the rear direction or vice versa without using an electronic component such as a motor and without providing a complicated switching mechanism in the interlocking body (lens drive member) that operates the optical element.

Although the embodiment of the present disclosure has been described above with reference to the above-described embodiment, the embodiments of the present disclosure are not limited to the above-described embodiment.

For example, in the case of the above-described embodiment, as illustrated in FIG. 10, a gear is cited as an example of a rotating body that drives and couples the lens drive member 28 that drives the lenses 16 and 18 and the rotation operation interlocking member 30 that is rotationally operated by the user. However, the present embodiment is not limited thereto. For example, an elastic roller, a magnetic roller, an electrostatic roller, an adhesive roller, or the like may be used as the rotating body. The lens drive member 28 and the rotation operation interlocking member 30 may be driven and coupled via a roller having an outer circumferential engagement portion that engages with the outer circumferential rotation engagement portion 28d of the portion of the outer circumferential surface of the lens drive member 28 and the inner circumferential rotation engagement portion 30b of the portion of the inner circumferential surface of the rotation operation interlocking member 30 by applying frictional force, magnetic force, electric force, adhesive force, or the like.

In addition, in the case of the above-described embodiment, the lens moving direction switching member 36 includes a key 36b. Each of the rotation operation interlocking member 30, the gear (rotating body) support member 34, and the outer cylindrical body 22 in the main body 12 includes key grooves 30d, 34c, and 22e to be engaged with the key 36b. However, the embodiment of the present disclosure is not limited thereto. For example, the lens moving direction switching member 36 may include a key groove, and each of the rotation operation interlocking member 30, the gear (rotating body) support member 34, and the main body 12 may include a key.

That is, in a broad sense, a lens barrel according to an embodiment of the present disclosure includes: a main body having a substantially cylindrical portion; one or a plurality of lenses; one or a plurality of lens support members that support the one or the plurality of lenses; a lens drive member having a substantially cylindrical portion that moves the one or the plurality of lens support members in a substantially extending direction of an optical axis in conjunction with rotation with respect to the main body nearly around the optical axis of the one or the plurality of lenses; a rotation operation interlocking member disposed radially outward of the lens drive member nearly around the optical axis and having a substantially cylindrical portion that rotates with respect to the main body nearly around the optical axis in conjunction with manual operation; an odd number of rotating bodies engaging with an outer circumferential surface of the lens drive member and an inner circumferential surface of the rotation operation interlocking member and capable of executing a rolling operation on the outer circumferential surface and the inner circumferential surface around a rotation center line substantially parallel to the optical axis and a circling operation around the optical axis; and a lens moving direction switching member that switches from a state in which the rolling operation of the odd number of rotating bodies is regulated and the circling operation is permitted to a state in which the rolling operation is permitted and the circling operation is regulated, or vice versa, in which a moving direction of the lens with respect to a rotation direction of the rotation operation interlocking member is switched by executing switching of the lens moving direction switching member.

The embodiment of the present disclosure is not limited to the lens barrel in which the lens is movable as described above, that is, the lens barrel in which the zoom amount or focus amount is adjustable. The configuration of the above-described embodiment can also be applied to a lens barrel capable of adjusting a aperture amount.

A lens barrel according to another embodiment will be described. That is, a case where the technology in the present disclosure is applied to a lens barrel that adjusts an amount of light (aperture amount (F value)) transmitted through a lens by opening and closing a diaphragm blade in a direction substantially orthogonal to an optical axis will be described. A lens barrel according to another embodiment includes at least one diaphragm blade that changes a size of an aperture by an opening/closing operation in a direction substantially orthogonal to an optical axis to adjust a passing amount of light, a drive ring that is rotated and driven nearly around the optical axis to open and close the diaphragm blade, and an annular-like base member that supports the diaphragm blade and the drive ring.

Specifically, each of the at least one diaphragm blade is supported by the annular-like base member so as to be rotatable around a rotation center line substantially parallel to the optical axis of the lens barrel. The drive ring is supported by the base member so as to be rotatable nearly around the optical axis. The drive ring is coupled to each of the at least one diaphragm blade via a cam mechanism. For example, a cam groove is formed in each of the at least one diaphragm blade, and at least one cam follower that engages with the cam groove of the at least one diaphragm blade is formed in the drive ring.

When the drive ring rotates nearly around the optical axis with respect to the base member, the at least one diaphragm blade rotates through the cam mechanism to perform an opening/closing operation in a direction substantially orthogonal to the optical axis. This drive ring corresponds to the lens drive member 28 in the above-described embodiment and has a similar function. That is, a lens barrel according to another embodiment corresponds to a lens barrel in which the lens 18, the inner cylindrical body 20, and the lens drive member 28 in the lens barrel 10 of the above-described embodiment are replaced with at least one diaphragm blade, the base member, and the drive ring. When an operation of moving the moving direction switching member (for diaphragm) from the front side to the back side or vice versa is performed in a state where an odd number of rotating bodies (for diaphragm) are engaged between the drive ring and an aperture ring (the rotation operation interlocking member (for diaphragm)), the rotating body (for diaphragm) can be switched from the rolling operation to the circling operation or vice versa, similarly to the embodiment of the present disclosure. As a result, the rotation direction of the drive ring with respect to the rotation direction of the aperture ring (the rotation operation interlocking member (for the diaphragm)) can be switched, and the opening/closing direction of the diaphragm blade with respect to the rotation direction of the aperture ring (the rotation operation interlocking member (for the diaphragm)) can be arbitrarily switched.

Therefore, in a broad sense, a lens barrel according to another embodiment of the present disclosure includes: one or a plurality of lenses; one or a plurality of diaphragm blades that adjust an amount of light passing through the one or a plurality of lenses; a substantially annular base member that rotatably supports the one or the plurality of diaphragm blades around a rotation center line parallel to an optical axis of the one or a plurality of lenses; a diaphragm blade drive member that opens and closes the one or a plurality of diaphragm blades in conjunction with rotation with respect to the base member nearly around an optical axis of the one or a plurality of lenses; a rotation operation interlocking member disposed radially outside the diaphragm blade drive member nearly around the optical axis, the rotation operation interlocking member including a substantially cylindrical portion rotated with respect to the main body nearly around the optical axis in conjunction with a manual operation; an odd number of rotating bodies engaging with an outer circumferential surface of the diaphragm blade drive member and an inner circumferential surface of the rotation operation interlocking member and capable of executing a rolling operation on the outer circumferential surface and the inner circumferential surface around a rotation center line substantially parallel to the optical axis and a circling operation around the optical axis; and a switching member that switches from a state in which the rolling operation of the odd number of rotating bodies is regulated and the circling operation is permitted to a state in which the rolling operation is permitted and the circling operation is regulated, or vice versa, in which opening and closing directions of the one or a plurality of diaphragm blades with respect to a rotation direction of the rotation operation interlocking member is switched by executing switching of the switching member.

Hereinafter, display of the focal length in the zoom operation will be described.

The display of the focal length in the prior art is performed by reading the relative rotation direction position of the rotation operation interlocking member 30 around the optical axis C1 with respect to the inner cylindrical body 20 or the outer cylindrical body 22 of the main body 12. A scale of the focal length from the wide-angle side to the telephoto side is marked on the cylindrical portion around the optical axis C1 of the inner cylindrical body 20 or the outer cylindrical body 22 of the main body 12, and an indicator that is arranged to face the scale of the focal length and indicates the position of the scale is marked on the rotation operation interlocking member 30. The members indicating the scale and the indicator may be reversed. In the zoom operation, the lens moves in conjunction with the relative rotation of the rotation operation interlocking member 30 with respect to the main body 12, and the focal length changes. At the same time, since the positional relationship between the focal length scale and the indicator also changes due to the relative rotation, the positional relationship between the focal length scale and the indicator also changes in accordance with the focal length change. In this way, it is possible to display the focal length (zoom position) that changes with the zoom operation in real time.

In the prior art, since the rotation operation interlocking member 30 and the lens drive member 28 that directly applies the driving force to the lens are directly connected in the rotation direction, the phases of the rotation operation interlocking member 30 and the lens drive member 28 in the rotation direction are completely synchronized without being shifted. Therefore, the position of the lens in the substantially extending direction (X-axis direction) of the optical axis C1 is also determined in a one-to-one relationship with respect to the rotational position of the rotation operation interlocking member 30, and as a result, the focal length is also determined. As a result, the focal length can be displayed by reading the relative rotation direction position of the rotation operation interlocking member 30 around the optical axis C1 with respect to the inner cylindrical body 20 or the outer cylindrical body 22 of the main body 12.

When the method for displaying a focal length according to the conventional technique is applied to a lens barrel adopting the technique in the present disclosure, there arises a problem that the focal length display cannot be correctly performed. In the lens barrel adopting the technology in the present disclosure, since the rotation operation interlocking member 30 and the lens drive member 28 that directly applies the driving force to the lens are not directly connected in the rotation direction, the phases in the rotation direction of the rotation operation interlocking member 30 and the lens drive member 28 may be shifted from each other and are not synchronized with each other. Therefore, the position of the lens in the substantially extending direction (X-axis direction) of the optical axis C1 may also deviate from the rotational position of the rotation operation interlocking member 30, and the position cannot be specified. As a result, the focal length cannot be determined. In the lens barrel adopting the technology in the present disclosure, an odd number of gears (rotating bodies) 32 capable of a circling operation and a rolling operation are inserted between the rotation operation interlocking member 30 and the lens drive member 28. Since the rotation directions of the rotation operation interlocking member 30 and the lens drive member 28 are the same direction during the circling operation of the gear (rotating body) 32 and are opposite directions during the rolling operation of the gear (rotating body) 32, when the circling operation and the rolling operation are switched in the middle of the zoom operation, the rotation direction and the phase of the rotation operation interlocking member 30 and the lens drive member 28 are shifted from each other and cannot be synchronized with each other.

In order to solve this problem, the focal length is displayed by reading the relative rotation direction position of the lens drive member 28 around the optical axis C1 with respect to the inner cylindrical body 20 or the outer cylindrical body 22 of the main body 12.

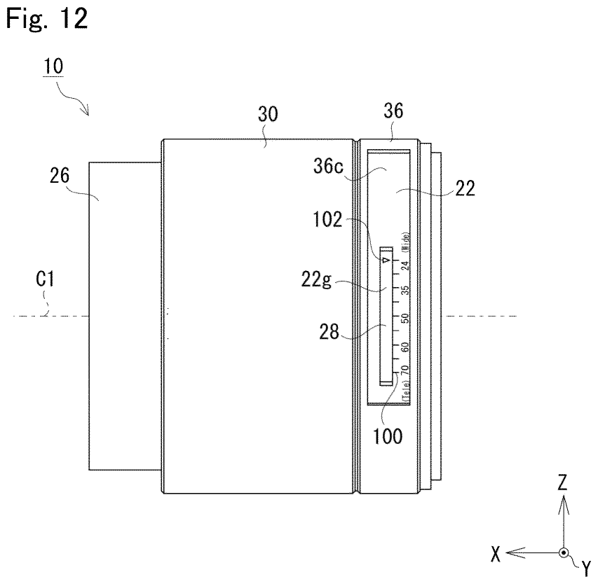

FIG. 12 is a side view of an example lens barrel including a scale of a focal length.

A scale 100 of the focal length from the wide-angle side to the telephoto side is marked on the cylindrical portion around the optical axis C1 of the inner cylindrical body 20 or the outer cylindrical body 22 of the main body 12 of the lens barrel 10, and an indicator 102 arranged to face the focal length scale 100 and indicating the position of the scale 100 is marked on the lens drive member 28.

In the example shown in FIG. 12, a scale 100 is marked on the outer cylindrical body 22. Conversely, the scale 100 may be written in the lens drive member 28, and the indicator 102 may be written in the outer cylindrical body 22 (or the inner cylindrical body 20). In the zoom operation, the lens moves in conjunction with the relative rotation of the lens drive member 28 with respect to the main body 12, and the focal length changes. At the same time, since the positional relationship between the focal length scale and the indicator also changes due to the relative rotation, the positional relationship between the focal length scale and the indicator also changes in accordance with the focal length change. In this way, it is possible to display the focal length (zoom position) that changes with the zoom operation in real time.

In this embodiment, since the focal length is displayed by directly reading the rotation position of the lens drive member 28 that directly applies the driving force to the lens with respect to the inner cylindrical body 20 or the outer cylindrical body 22 of the main body 12, the position of the lens in the substantially extending direction (X-axis direction) of the optical axis C1 is determined in a one-to-one relationship with respect to the rotation position of the lens drive member 28 without being shifted. As a result, the focal length is also determined. Since a member that changes the rotation direction or shifts the phase in the rotation direction unlike the gear (rotating body) 32 is not interposed between the lens drive member 28 and the lens, it is possible to display the focal length by providing the focal length scale 100 on one of the main body 12 (inner cylindrical body 20, outer cylindrical body 22) and the lens drive member 28 and the indicator 102 on the other. In this way, the focal length can be correctly displayed also in the lens barrel adopting the technology of the present disclosure.

As illustrated in FIG. 3, the main body 12 (inner cylindrical body 20, outer cylindrical body 22) and the lens drive member 28 are disposed on a relatively inner diameter side (radially inner side) of the lens barrel 10, and the members on an outer diameter side (radially outer side) are in the way, so that the main body and the lens drive member are hardly visible from a surface side (outer diameter side, radially outward) of the lens barrel 10. Therefore, even if the focal length scale 100 and the indicator 102 are written on the main body 12 (inner cylindrical body 20, outer cylindrical body 22) and the lens drive member 28, they may not be visible. As a countermeasure, a window 22g, 36c constituted by a hole, a notch, or a transparent portion may be provided in a member located on the outer diameter side (radially outer side) with respect to the portion where the focal length scale 100 and the indicator 102 of the main body 12 (inner cylindrical body 20, outer cylindrical body 22) and the lens drive member 28 are indicated, specifically, the outer cylindrical body 22, or the rotation operation interlocking member 30, or the lens moving direction switching member 36, or these two members, or these three members, so that the inner diameter side (radially inner side) can be seen from the window 22g, 36c. In this way, the portion where the focal length scale 100 and the indicator 102 are marked can be visually observed from the surface side (outer diameter side, radially outward) of the lens barrel 10.

In the example illustrated in FIG. 12, a through hole-shaped window 36c is formed in the lens moving direction switching member 36, and a through hole-shaped window 22g is formed in the outer cylindrical body 22. While the focal length scale 100 of the outer cylindrical body 22 is visibly exposed through the window 36c, the indicator 102 of the lens drive member 28 is visibly exposed through the two windows 36c and 22g. If there is concern that foreign objects or dust may enter in the lens parrel 10 through the through hole-shaped windows 22g, 36c, the windows 22g, 36c may be covered with a transparent material as a countermeasure.

In the lens barrel adopting the above-described technology in the present disclosure, the method for correctly displaying the focal length can be applied to a focusing operation and a diaphragm operation in addition to a zoom operation. The photographing distance scale and the indicator in the case of the focus operation, and the aperture value (F value) scale and the indicator in the case of the diaphragm operation may be written on the main body 12 (inner cylindrical body 20, outer cylindrical body 22) and the lens drive member 28. An effect similar to that in the case of the zoom operation can be obtained.

As described above, the embodiment has been described as an example of the technology in the present disclosure. For this purpose, the drawings and detailed description are provided. Accordingly, among the components described in the drawings and the detailed description, not only the components essential for solving the problem, but also the components not essential for solving the problem may also be included in order to exemplify the above technology. Therefore, it should not be immediately recognized that these non-essential components are essential as those non-essential components are described in the drawings and detailed description.

Moreover, since the above-mentioned embodiment is for exemplifying the technology in the present disclosure, various changes, substitutions, additions, omissions, etc. can be performed in a claim or its equivalent range.

The present disclosure is applicable to a lens barrel having a structure in which a lens is manually moved in a substantially extending direction of an optical axis.

What is claimed is:

1. A lens barrel, comprising:
a main body having a substantially cylindrical portion;
one or a plurality of lenses;
one or a plurality of lens support members that support the one or the plurality of lenses;
a lens drive member having a substantially cylindrical portion that moves the one or the plurality of lens support members in a substantially extending direction of an optical axis in conjunction with rotation with respect to the main body nearly around the optical axis of the one or the plurality of lenses;
a rotation operation interlocking member disposed radially outward of the lens drive member nearly around the optical axis, the rotation operation interlocking member including a substantially cylindrical portion rotated with respect to the main body nearly around the optical axis in conjunction with a manual operation;
an odd number of rotating bodies engaging with an outer circumferential surface of the lens drive member and an inner circumferential surface of the rotation operation interlocking member and capable of executing a rolling operation on the outer circumferential surface and the inner circumferential surface around a rotation center line substantially parallel to the optical axis and a circling operation around the optical axis; and
a lens moving direction switching member that switches from a state in which the rolling operation of the odd number of rotating bodies is regulated and the circling operation is permitted to a state in which the rolling operation is permitted and the circling operation is regulated, or vice versa, wherein
a moving direction of the lens with respect to a rotation direction of the rotation operation interlocking member is switched by executing switching of the lens moving direction switching member.

2. The lens barrel according to claim 1, further comprising a rotating body support member that supports the odd number of rotating bodies so as to be rotatable with respect to the rotation center line and is rotatable nearly around the optical axis,
wherein by executing switching of the lens moving direction switching member, the rotating body support member is switched from a state of rotating around the optical axis to a state of not rotating, or vice versa.

3. The lens barrel according to claim 2, wherein switching of the lens moving direction switching member is executed to switch from a state in which the rotation operation interlocking member is substantially fixed to the rotating body support member to a state in which the main body is substantially fixed to the rotating body support member, or vice versa.

4. The lens barrel according to claim 3, wherein
the lens moving direction switching member is a member having a substantially cylindrical portion supported on an outer circumferential surface of the rotation operation interlocking member so as to be movable in a substantially extending direction of the optical axis,
the lens moving direction switching member includes one or a plurality of keys extending in a substantially extending direction of the optical axis on an inner circumferential surface,
each of the rotation operation interlocking member, the rotating body support member, and the main body includes one or a plurality of key grooves that engage with the one or the plurality of keys of the lens moving direction switching member, and
the one or the plurality of keys are engaged with the one or the plurality of key grooves of both the rotation operation interlocking member and the rotating body support member to substantially fix the rotation operation interlocking member to the rotating body support member, and the one or the plurality of keys are engaged with the one or the plurality of key grooves of both the main body and the rotating body support member to substantially fix the main body to the rotating body support member.

5. The lens barrel according to claim 1, wherein
an outer circumferential rotation engagement portion that engages with one of the odd number of rotating bodies is provided in a portion of an outer circumferential surface of the lens drive member facing the odd number of rotating bodies,
an inner circumferential rotation engagement portion to be engaged with one of the odd number of rotating bodies is provided in a portion of an inner circumferential surface of the rotation operation interlocking member facing the odd number of rotating bodies, and
the outer circumferential rotation engagement portion, the odd number of rotating bodies, and the inner circumferential rotation engagement portion are arranged in series, engage with each other, and transmit rotation.

6. The lens barrel according to claim 1, wherein
the odd number of rotating bodies are an odd number of gears,
the outer circumferential rotation engagement portion is an outer circumferential gear formed in a portion of an outer circumferential surface of the lens drive member, and
the inner circumferential rotation engagement portion is an inner circumferential gear formed in a portion of an inner circumferential surface of the rotation operation interlocking member.

7. The lens barrel according to claim 1, wherein the odd number of rotating bodies include one or a plurality of idle rotating bodies.

8. The lens barrel according to claim 7, wherein
the odd number of rotating bodies are an odd number of gears,
the outer circumferential rotation engagement portion is an outer circumferential gear formed in a portion of an outer circumferential surface of the lens drive member, and
the inner circumferential rotation engagement portion is an inner circumferential gear formed in a portion of an inner circumferential surface of the rotation operation interlocking member.

9. The lens barrel according to claim 1, wherein the odd number of rotating bodies include one or a plurality of two-stage rotating bodies in which a first rotating body and a second gear having an outer diameter larger than that of the first rotating body are integrally formed in a coaxial state.

10. The lens barrel according to claim 9, wherein
the odd number of rotating bodies are an odd number of gears,
the outer circumferential rotation engagement portion is an outer circumferential gear formed in a portion of an outer circumferential surface of the lens drive member, and
the inner circumferential rotation engagement portion is an inner circumferential gear formed in a portion of an inner circumferential surface of the rotation operation interlocking member.

11. The lens barrel according to claim 1, wherein
the lens drive member includes one or a plurality of cam grooves, and
the one or the plurality of lens support members include a cam follower that engages with the one or the plurality of cam grooves of the lens drive member.

12. The lens barrel according to claim 1, wherein
the lens includes two or more lenses provided to be relatively movable in a substantially extending direction of the optical axis, and
a focal length is changed by relatively moving the two or more lenses in a substantially extending direction of an optical axis.

13. The lens barrel according to claim 1, wherein one of the main body and the lens drive member is provided with a scale indicating a photographing condition, and the other is provided with an indicator indicating a position of the scale.

14. A lens barrel comprising:
one or a plurality of lenses;
one or a plurality of diaphragm blades that adjust an amount of light passing through the one or a plurality of lenses;
a substantially annular base member that rotatably supports the one or the plurality of diaphragm blades around a rotation center line parallel to an optical axis of the one or a plurality of lenses;
a diaphragm blade drive member that opens and closes the one or a plurality of diaphragm blades in conjunction with rotation with respect to the base member nearly around an optical axis of the one or a plurality of lenses;
a rotation operation interlocking member disposed radially outside the diaphragm blade drive member nearly around the optical axis, the rotation operation interlocking member including a substantially cylindrical portion rotated with respect to the main body nearly around the optical axis in conjunction with a manual operation;
an odd number of rotating bodies engaging with an outer circumferential surface of the diaphragm blade drive member and an inner circumferential surface of the rotation operation interlocking member and capable of executing a rolling operation on the outer circumferential surface and the inner circumferential surface around a rotation center line substantially parallel to the optical axis and a circling operation around the optical axis; and
a switching member that switches from a state in which the rolling operation of the odd number of rotating bodies is regulated and the circling operation is permitted to a state in which the rolling operation is permitted and the circling operation is regulated, or vice versa, wherein
opening and closing directions of the one or a plurality of diaphragm blades with respect to a rotation direction of the rotation operation interlocking member is switched by executing switching of the switching member.
